(19) United States
(12) Patent Application Publication
(10) Pub. No.: US 2011/0102762 A1
(43) Pub. Date: May 5, 2011

(54) EXPOSURE APPARATUS AND DEVICE MANUFACTURING METHOD

(75) Inventor: Go ICHINOSE, Fukaya-shi (JP)

(73) Assignee: NIKON CORPORATION, Tokyo (JP)

(21) Appl. No.: 12/911,089

(22) Filed: Oct. 25, 2010

Related U.S. Application Data
(60) Provisional application No. 61/272,898, filed on Nov. 17, 2009.

(30) Foreign Application Priority Data
Oct. 30, 2009 (JP) 2009-250128

(51) Int. Cl. G03B 27/58

(52) U.S. Cl. 355/72; 355/77

(57) ABSTRACT

An exposure apparatus is equipped with a wafer stage which holds a wafer and to which one ends of flat tubes having flexibility that transmit the power usage for exposure between the wafer stage and a predetermined external device are connected and which is movable along an XY plane, and a tube carrier which is placed on one side of the wafer stage in an X-axis direction, to which the other ends of the flat tubes are connected, and which moves along the XY plane according to movement of the wafer stage and also moves to the other side in the X-axis direction when the wafer stage moves to the one side in the X-axis direction. Accordingly, the wafer stage hardly receives the drag (tensile force) from the flat tubes and outward protrusion of the flat tubes in the X-axis direction can be restrained.

### CROSS-REFERENCE TO RELATED APPLICATIONS

This non-provisional application claims the benefit of Provisional Application No. 61/272,898 filed Nov. 17, 2009, the disclosure of which is hereby incorporated herein by reference in its entirety.

### BACKGROUND OF THE INVENTION

1. Field of the Invention

The present invention relates to exposure apparatuses and device manufacturing methods, and more particularly to an exposure apparatus that exposes an object with an energy beam via an optical system, and a device manufacturing method that uses the exposure apparatus.

2. Description of the Background Art

Conventionally, in a lithography process for manufacturing electron devices (microdevices) such as semiconductor devices (integrated circuits or the like) or liquid crystal display elements, an exposure apparatus such as a projection exposure apparatus by a step-and-repeat method (a so-called stepper), or a projection exposure apparatus by a step-and-scan method (a so-called scanning stepper (which is also called a scanner)) is mainly used.

A substrate such as a wafer or a glass plate that is subject to exposure used in this type of the exposure apparatus has been gradually (e.g. every ten years in the case of the wafer) grown in size. While a 300 mm-wafer with a diameter of 300 mm currently becomes mainstream, the coming of age of the 450 mm-wafer with a diameter of 450 mm looms near. When the size of the wafer shifts to 450 mm, the number of dies (chips) obtained from one wafer is twice or more of that of the current 300 mm-wafer, which contributes to the cost reduction.

Meanwhile, when the size of the wafer becomes as large as 450 mm, as the number of dies (chips) obtained from one wafer is increased, the time required for exposure processing of one wafer is increased, which decrease the throughput. Therefore, as a method to suppress the decrease in throughput as much as possible, employment of a twin-stage method (e.g. refer to U.S. Pat. No. 6,590,634, U.S. Pat. No. 5,969,441, U.S. Pat. No. 6,208,407 and the like) can be considered in which the exposure processing with respect to a wafer on one wafer stage and processing such as wafer exchange and alignment on another wafer stage are performed in parallel.

However, a wafer stage to cope with the 450 mm-wafer grows in size and the footprint of an apparatus increase in size. Especially, in the twin stage method, the footprint further increases. In addition, the movable range of the wafer stage that has grown in size becomes larger compared with the conventional one, and therefore, there was a risk that movement of the wafer stage is blocked by a tensile force of a tube that extracts/contracts in accordance with the movement of the wafer stage and is used to supply the power usage to the wafer stage. Further, a space needs to be secured in a lateral direction of a stage device in order not to inhibit deformation of the tube, and accordingly there was a risk that the throughput is further decreased.

### SUMMARY OF THE INVENTION

According to a first aspect of the present invention, there is provided an exposure apparatus that exposes an object by irradiating the object with an energy beam, the apparatus comprising: a movable body, which holds the object, to which one end of a power usage transmitting member is connected, and which is movable along a first plane parallel to a predetermined two-dimensional plane that includes a first axis and a second axis orthogonal to each other, the power usage transmitting member having flexibility that forms a transmission path used when a power usage for the exposure is transmitted between the movable body and a predetermined external device; and an auxiliary movable body, which is placed on one side in a direction parallel to the first axis with respect to the movable body, to which the other end of the power usage transmitting member is connected, and which moves along a second plane parallel to the two-dimensional plane according to movement of the movable body and moves to the other side in the direction parallel to the first axis when the movable body moves to the one side in the direction parallel to the first axis.

With this apparatus, when the movable body that holds an object moves to one side of a direction parallel to the first axis, the auxiliary movable body used to transmit the power usage for exposure to the movable body via the power usage transmitting member moves to the other side of the direction parallel to the first axis. Therefore, the movable body is hardly affected by the drag (tensile force) by the power usage transmitting member, and also the protrusion of the power usage transmitting member in the direction parallel to the first axis is restrained.

According to a second aspect of the present invention, there is provided a device manufacturing method, comprising: exposing an object using the exposure apparatus of the present invention; and developing the object that has been exposed.

### BRIEF DESCRIPTION OF THE DRAWINGS

In the accompanying drawings;

FIG. 1 is a view schematically showing a configuration of an exposure apparatus related to an embodiment;

FIG. 2 is a plan view of the exposure apparatus shown in FIG. 1;

FIG. 3 is a side view of the exposure apparatus shown in FIG. 1 when viewed from the +Y side;

FIG. 4A is a plan view of a wafer stage, FIG. 4B is an end view of the cross section taken along the line B-B in FIG. 4A, and FIG. 4C is an end view of the cross section taken along the line C-C in FIG. 4A;

FIGS. 5A and 5B are a plan view and a side view showing a configuration of a tube carrier, respectively;

FIGS. 6A to 6D are views used to explain a follow-up drive of the tube carrier with respect to the wafer stage;

FIG. 7 is a view showing a configuration of a fine movement stage position measuring system; and

FIG. 8 is a block diagram used to explain input/output relations of a main controller which the exposure apparatus shown in FIG. 1 is equipped with.

### DESCRIPTION OF THE EMBODIMENTS

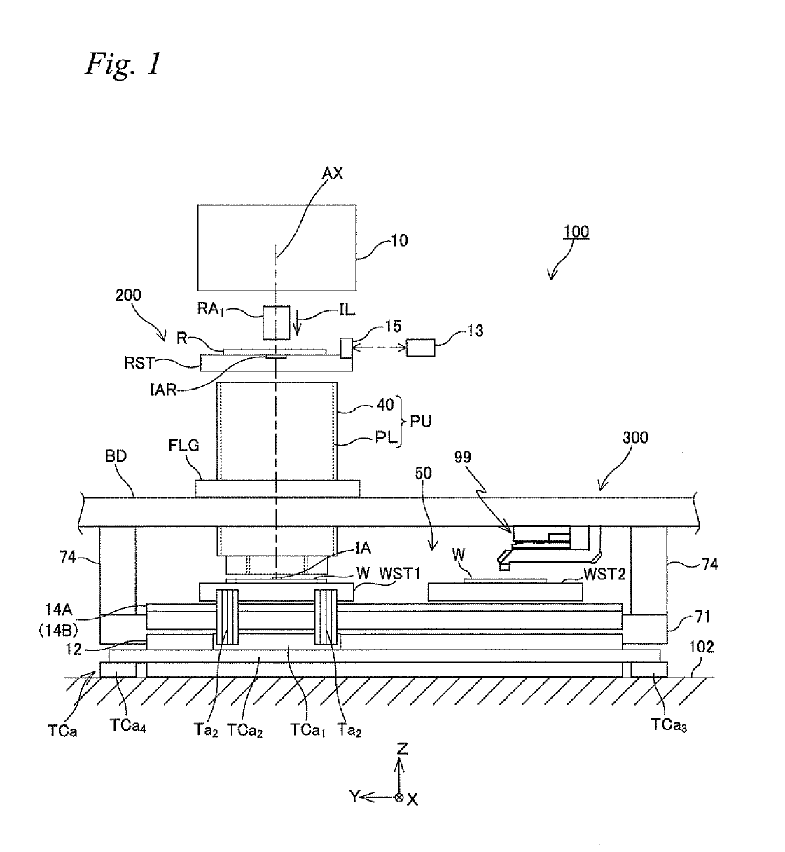

An embodiment of the present invention is described below, with reference to FIGS. 1 to 8.

FIG. 1 schematically shows a configuration of an exposure apparatus 100 related to the embodiment. Exposure apparatus 100 is a projection exposure apparatus by a step-and-scan method, which is a so-called scanner. As described later on, a projection optical system PL is provided in the embodiment, and in the description below, the explanation is given assuming that a direction parallel to an optical axis AX of projection optical system PL is a Z-axis direction, a direction in which a reticle and a wafer are relatively scanned within a plane orthogonal to the Z-axis direction is a Y-axis direction, and a direction orthogonal to the Z-axis and the Y-axis is an X-axis direction, and rotational (tilt) directions around the X-axis, Y-axis and Z-axis are θx, θy and θz directions, respectively.

As shown in FIG. 1, exposure apparatus 100 is equipped with an exposure station 200 placed in the vicinity of the +Y side end on abase board 12, a measurement station 300 placed in the vicinity of the −Y side end on base board 12, a stage device 50 that includes two wafer stages WST1 and WST2, their control system and the like. In FIG. 1, wafer stage WST1 is located in exposure station 200 and a wafer W is held on wafer stage WST1. And, wafer stage WST2 is located in measurement station 300 and another wafer W is held on wafer stage WST2.

Exposure station 200 is equipped with an illuminations system 10, a reticle stage RST, a projection unit PU, and the like.

Illumination system 10 includes: a light source; and an illumination optical system that has an illuminance uniformity optical system including an optical integrator and the like, and a reticle blind and the like (none of which are illustrated), as disclosed in, for example, U.S. Patent Application Publication No. 2003/0025890 and the like. Illumination system 10 illuminates a slit-shaped illumination area IAR, which is defined by the reticle blind (which is also referred to as a masking system), on reticle R with illumination light (exposure light) IL with substantially uniform illuminance. As illumination light IL, ArF excimer laser light (wavelength: 193 nm) is used as an example.

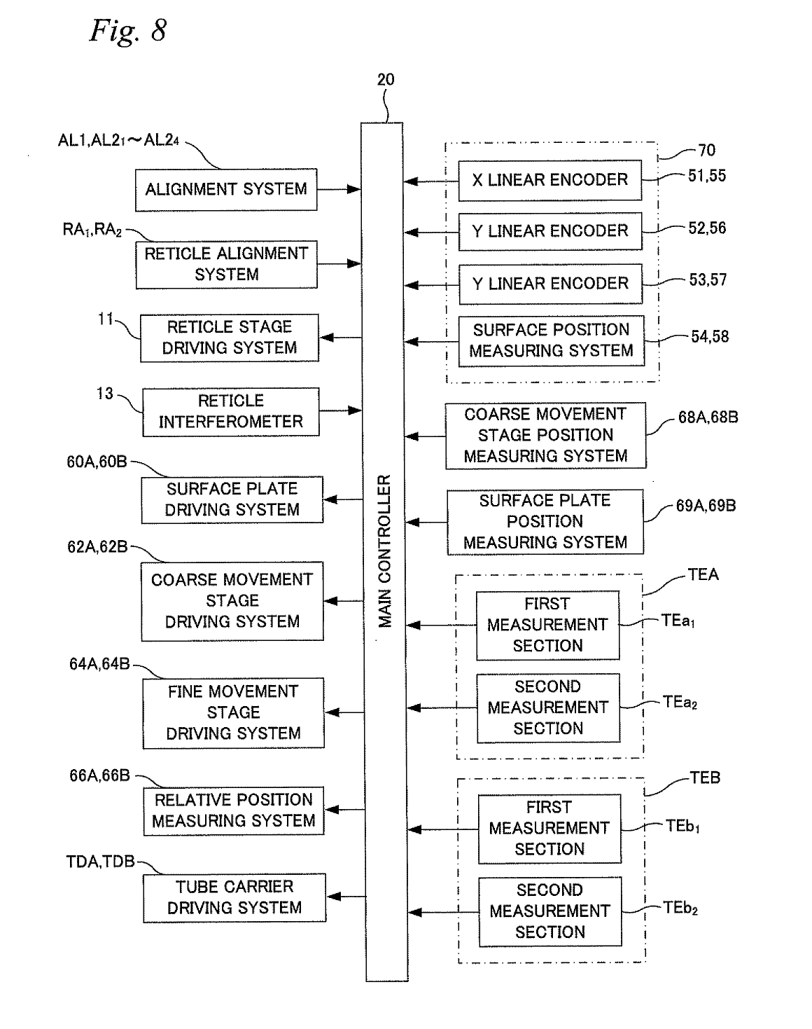

On reticle stage RST, reticle R having a pattern surface (the lower surface in FIG. 1) on which a circuit pattern and the like are formed is fixed by, for example, vacuum adsorption. Reticle stage RST can be driven with a predetermined stroke at a predetermined scanning speed in a scanning direction (which is the Y-axis direction being a lateral direction of the page surface of FIG. 1) and can also be finely driven in the X-axis direction, with a reticle stage driving system 11 (not illustrated in FIG. 1, see FIG. 8) including, for example, a linear motor or the like.

Positional information within the XY plane (including rotational information in the θz direction) of reticle stage RST is constantly detected at a resolution of, for example, around 0.25 nm with a reticle laser interferometer (hereinafter, referred to as a “reticle interferometer”) 13 via a movable mirror 15 fixed to reticle stage RST (actually, a Y movable mirror (or a retroreflector) that has a reflection surface orthogonal to the Y-axis direction and an X movable mirror that has a reflection surface orthogonal to the X-axis direction are arranged). The measurement values of reticle interferometer 13 are sent to a main controller 20 (not illustrated in FIG. 1, see FIG. 8) Incidentally, as disclosed in, for example, U.S. Patent Application Publication No. 2007/0288121 and the like, the positional information of reticle stage RST can be measured by an encoder system.

Above reticle stage RST, a pair of reticle alignment systems RA₁ and RA₂ by an image processing method, each of which has an imaging device such as a CCD and uses light with an exposure wavelength (illumination light IL in the embodiment) as alignment illumination light, are placed (in FIG. 1, reticle alignment system RA₂ is hidden behind reticle alignment system RA₁ in the depth of the page surface), as disclosed in detail in, for example, U.S. Pat. No. 5,646,413 and the like. Main controller 20 detects projected images of a pair of reticle alignment marks (the illustration is omitted) formed on reticle R and a pair of first fiducial marks on a measurement plate, which is described later, on fine movement stage WFS1 (or WFS2), that correspond to the reticle alignment marks via projection optical system PL in a state where the measurement plate is located directly under projection optical system PL, and the pair of reticle alignment systems RA₁ and RA₂ are used to detect a positional relation between the center of a projection area of a pattern of reticle R by projection optical system PL and a fiducial position on the measurement plate, i.e. the center of the pair of the first fiducial marks, according to such detection performed by main controller 20. The detection signals of reticle alignment systems RA₁ and RA₂ are supplied to main controller 20 (see FIG. 8) via a signal processing system that is not illustrated. Incidentally, reticle alignment systems RA₁ and RA₂ do not have to be arranged. In such a case, it is preferable that a detection system that has a light-transmitting section (photodetection section) arranged at the fine movement stage, which is described later on, is installed so as to detect projected images of the reticle alignment marks, as disclosed in, for example, U.S. Patent Application Publication No. 2002/0041377 and the like.

Projection unit PU is placed below reticle stage RST in FIG. 1. Projection unit PU is supported, via a flange section FLG that is fixed to the outer periphery of projection unit PU, by a main frame (which is also referred to as a metrology frame) BD that is horizontally supported by a support member that is not illustrated. Projection unit PU includes a barrel 40 and projection optical system PL held within barrel 40. As projection optical system PL, for example, a dioptric system that is composed of a plurality of optical elements (lens elements) that are disposed along optical axis AX parallel to the Z-axis direction is used. Projection optical system PL is, for example, both-side telecentric and has a predetermined projection magnification (e.g. one-quarter, one-fifth, one-eighth times, or the like). Therefore, when illumination area IAR on reticle R is illuminated with illumination light IL from illumination system 10, illumination light IL, which has passed through reticle R whose pattern surface is placed substantially coincident with a first plane (object plane) of projection optical system PL, forms a reduced image of a circuit pattern (a reduced image of a part of a circuit pattern) of reticle R within illumination area IAR is formed, on an area (hereinafter, also referred to as an exposure area) IA that is conjugate to illumination area IAR described above on wafer W, which is placed on the second plane (image plane) side of projection optical system PL and whose surface is coated with a resist (sensitive agent), via projection optical system PL (projection unit PU). Then, by moving reticle R relative to illumination area IAR (illumination light IL) in the scanning direction (Y-axis direction) and also moving wafer W relative to exposure area IA (illumination light IL) in the scanning direction (Y-axis direction) by synchronous drive of reticle stage RST and wafer stage WST1 (or WST2), scanning exposure of one shot area (divided area) on wafer W is performed, and a pattern of reticle R is transferred onto the shot area. More specifically, in the embodiment, a pattern of reticle R is generated on wafer W by illumination system 10 and projection optical system PL, and the pattern is formed on wafer W by exposure of a sensitive layer (resist layer) on wafer W with illumination light IL. In this case, projection unit PU is held by main frame BD, and in the embodiment, main frame BD is substantially horizontally supported by a plurality (e.g. three or four) of support members placed on an installation surface (such as a floor surface) each via a vibration isolating mechanism. Incidentally, the vibration isolating mechanism can be placed between each of the support members and main frame BD. Further, as disclosed in, for example, PCT International Publication No. 2006/038952, main frame BD (projection unit PU) can be supported in a suspended manner by a main frame member (not illustrated) placed above projection unit PU or a reticle base or the like.

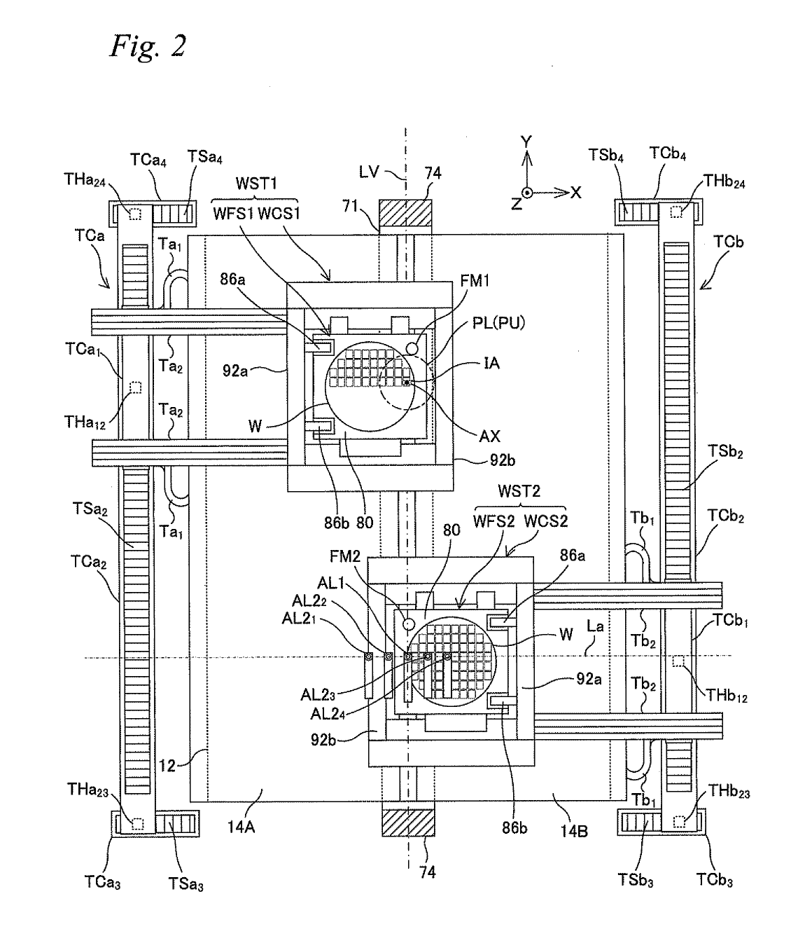

Measurement station 300 is equipped with an alignment device 99 arranged at main frame BD. Alignment device 99 includes five alignment systems AL1 and AL2₁ to AL2₄ shown in FIG. 2, as disclosed in, for example, U.S. Patent Application Publication No. 2008/0088843 and the like. To be more specific, as shown in FIG. 2, a primary alignment system AL1 is placed in a state where its detection center is located at a position a predetermined distance apart on the −Y side from optical axis AX, on a straight line (hereinafter, referred to as a reference axis) LV that passes through the center of projection unit PU (which is optical axis AX of projection optical system PL, and in the embodiment, which also coincides with the center of exposure area IA described previously) and is parallel to the Y-axis. On one side and the other side in the X-axis direction with primary alignment system AL1 in between, secondary alignment systems AL2₁ and AL2₂, and AL2₃ and AL2₄, whose detection centers are substantially symmetrically placed with respect to reference axis LV, are arranged respectively. More specifically, the detection centers of the five alignment systems AL1 and AL2₁ to AL2₄ are placed along a straight line (hereinafter, referred to as a reference axis) La that vertically intersects reference axis LV at the detection center of primary alignment system AL1 and is parallel to the X-axis. Note that a configuration including the five alignment systems AL1 and AL2₁ to AL2₄ and a holding device (slider) that holds these alignment systems is shown as alignment device 99 in FIG. 1. As disclosed in, for example, U.S. Patent Application Publication No. 2009/0233234 and the like, secondary alignment systems AL2₁ to AL2₄ are fixed to the lower surface of main frame BD via the movable slider (see FIG. 1), and the relative positions of the detection areas of the secondary alignment systems are adjustable at least in the X-axis direction with a drive mechanism that is not illustrated.

In the embodiment, as each of alignment systems AL1 and AL2₁ to AL2₄, for example, an FIA (Field Image Alignment) system by an image processing method is used. The configurations of alignment systems AL1 and AL2₁ to AL2₄ are disclosed in detail in, for example, PCT International. Publication No. 2008/056735 and the like. The imaging signal from each of alignment systems AL1 and AL2₁ to AL2₄ is supplied to main controller 20 (see FIG. 8) via a signal processing system that is not illustrated.

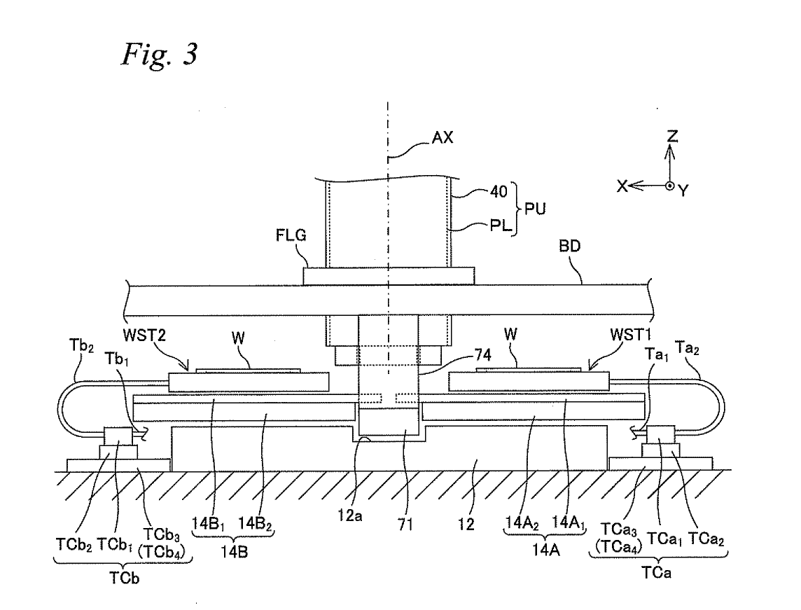

As shown in FIG. 1, stage device 50 is equipped with base board 12, a pair of surface plates 14A and 14B placed above base board 12 (in FIG. 1, surface plate 14B is hidden behind surface plate 14 in the depth of the page surface), the two wafer stages WST1 and WST2 that move on a guide surface parallel to the XY plane that is formed by the upper surfaces of the pair of surface plates 14A and 14B, tube carrier devices TCa and TCb (tube carrier device TCb is not illustrated in FIG. 1, see the drawings such as FIGS. 2 and 3) that are respectively connected to wafer stages WST1 and WST2 via piping/wiring systems (hereinafter, referred to as flat tubes for the sake of convenience) Ta₂ and Tb₂ (not illustrated in FIG. 1, see FIGS. 2 and 3), a measurement system that measures positional information of wafer stages WST1 and WST2, and the like. The power supply electric power (electric current) for various types of sensors, motors or an electrostatic chuck mechanism and the like, the coolant for cooling the motors, the pressurized air for air bearings, and the like are supplied from the outside to wafer stages WST1 and WST2 via flat tubes Ta₂ and Tb₂ (and flat tubes Ta₁ and Tb₁ to be described later), respectively. Note that, in the description below, the power supply electric power (electric current), the pressurized air and the like are also referred to as the power usage collectively. In the case where a vacuum suction force is necessary, the vacuum suction force is also included in the power usage. Further, the wiring used to transfer output signals from the various types of sensors and control signals to the motors and the like is also included in flat tubes Ta₂ and Tb₂ (and flat tubes Ta₁ and Tb₁ to be described later).

Base board 12 is made up of a member having a tabular outer shape, and as shown in FIG. 1, is substantially horizontally (parallel to the XY plane) supported via a vibration isolating mechanism (the illustration is omitted) on a floor surface 102. In the center portion in the X-axis direction of the upper surface of base board 12, a recessed section 12a (recessed groove) extending in a direction parallel to the Y-axis is formed, as shown in FIG. 3. On the upper surface side of base board 12 (excluding a portion where recessed section 12a is formed, in this case), a coil unit (the illustration is omitted) is housed that includes a plurality of coils placed in a matrix shape with the XY two-dimensional directions serving as a row direction and a column direction.

As shown in FIG. 2, surface plates 14A and 14B are each made up of a rectangular plate-shaped member whose longitudinal direction is in the Y-axis direction in a planar view (when viewed from above) and are respectively placed on the −X side and the +X side of reference axis LV. Surface plate 14A and surface plate 14B are placed with a very narrow gap in between in the X-axis direction, symmetric with respect to reference axis LV. The upper surface (the +Z side surface) of each of surface plates 14A and 14B is finished so as to have a very high flatness degree, and functions as a guide surface used when each of wafer stages WST1 and WST2 moves along the XY plane.

As shown in FIG. 3, surface plates 14A and 14B are supported on base board 12 on both sides of recessed section 12a via air bearings (or rolling bearings) that are not illustrated.

Surface plates 14A and 14B respectively have first sections 14A₁ and 14B₁ each having a relatively thin plate shape on the upper surface of which the guide surface is formed, and second sections 14A₂ and 14B₂ each having a relatively thick plate shape and being short in the X-axis direction that are integrally fixed to the lower surfaces of first sections 14A₁ and 14B₁, respectively. The end on the +X side of first section 14A₁ of surface plate 14A slightly overhangs, to the +X side, the end surface on the +X side of second section 14A₂, and the end on the −X side of first section 14B₁ of surface plate 14B slightly overhangs, to the −X side, the end surface on the −X side of second section 14B₂.

Inside each of first sections 14A₁ and 14B₁, a coil unit (the illustration is omitted) is housed that includes a plurality of coils placed in a matrix shape with the XY two-dimensional directions serving as a row direction and a column direction. The magnitude and the direction of the electric current supplied to each of the plurality of coils that configure each of the coil units are controlled by main controller 20 (see FIG. 8).

Inside (on the bottom portion of) second section 14A₂ of surface plate 14A, a magnet unit (the illustration is omitted), which is made up of a plurality of permanent magnets (and yokes that are not illustrated) placed in a matrix shape with the XY two-dimensional directions serving as a row direction and a column direction, is housed so as to correspond to the coil unit housed on the upper surface side of base board 12. The magnet unit configures, together with the coil unit of base board 12, a surface plate driving system 60A (see FIG. 8) that is made up of a planar motor by the electromagnetic force (Lorentz force) drive method that is disclosed in, for example, U.S. Patent Application Publication No. 2003/0085676 and the like. Surface plate driving system 60A generates a drive force that drives surface plate 14A in directions of three degrees of freedom (X, Y, θz) within the XY plane.

Similarly, inside (on the bottom portion of) second section 14B₂ of surface plate 14B, a magnet unit (the illustration is omitted) made up of a plurality of permanent magnets (and yokes that are not illustrated) is housed that configures, together with the coil unit of base board 12, a surface plate driving system 60B (see FIG. 8) made up of a planar motor that drives surface plate 14B in the directions of three degrees of freedom within the XY plane. Incidentally, the placement of the coil unit and the magnet unit of the planar motor that configures each of surface plate driving systems 60A and 603 can be reversed (a moving coil type that has the magnet unit on the base board side and the coil unit on the surface plate side) to the above-described case (a moving magnet type).

Positional information of surface plates 14A and 14B in the directions of three degrees of freedom is measured independently from each other by a first surface plate position measuring system 69A and a second surface plate position measuring system 69B (see FIG. 8), respectively, which each include, for example, an encoder system. The output of each of first surface plate position measuring system 69A and second surface plate position measuring system 69B is supplied to main controller 20 (see FIG. 8), and main controller 20 controls the magnitude and the direction of the electric current supplied to the respective coils that configure the coil units of surface plate driving systems 60A and 60B, based on the outputs of surface plate position measuring systems 69A and 69B, thereby controlling the respective positions of surface plates 14A and 14B in the directions of three degrees of freedom within the XY plane, as needed. Main controller 20 drives surface plates 14A and 14B via surface plate driving systems 60A and 60B based on the outputs of surface plate position measuring systems 69A and 69B to return surface plates 14A and 14B to the reference position of the surface plates such that the movement distance of surface plates 14A and 14B from the reference position falls within a predetermined range, when surface plates 14A and 14B function as countermasses to be described later on. More specifically, surface plate driving systems 60A and 60B are used as trim motors.

While the configurations of first surface plate position measuring system 69A and second surface plate position measuring system 69B are not especially limited, an encoder system can be used in which, for example, encoder heads, which measure positional information of the respective surface plates 14A and 14B in the directions of three degrees of freedom within the XY plane by irradiating measurement beams on scales (e.g. two-dimensional gratings) placed on the lower surfaces of second sections 14A₂ and 14B₂ respectively and using reflected light (diffraction light from the two-dimensional gratings) obtained by the irradiation, are placed at base board 12 (or the encoder heads are placed at second sections 14A₂ and 14B₂ and scales are placed at base board 12, respectively). Incidentally, it is also possible to measure the positional information of surface plates 14A and 14B by, for example, an optical interferometer system or a measurement system that is a combination of an optical interferometer system and an encoder system.

One of the wafer stages, wafer stage WST1 is equipped with fine movement stage WFS1 that holds wafer W and a coarse movement stage WCS1 having a rectangular frame shape that encloses the periphery of fine movement stage WFS1, as shown in FIG. 2. The other of the wafer stages, wafer stage WST2 is equipped with fine movement stage WFS2 that holds wafer W and a coarse movement stage WCS2 having a rectangular frame shape that encloses the periphery of fine movement stage WFS2, as shown in FIG. 2. As is obvious from FIG. 2, wafer stage WST2 has completely the same configuration including the drive system, the position measuring system and the like, as wafer stage WST1 except that wafer stage WST2 is placed in a state laterally reversed with respect to wafer stage WST1. Consequently, in the description below, wafer stage WST1 is representatively focused on and described, and wafer stage WST2 is described only in the case where such description is especially needed.

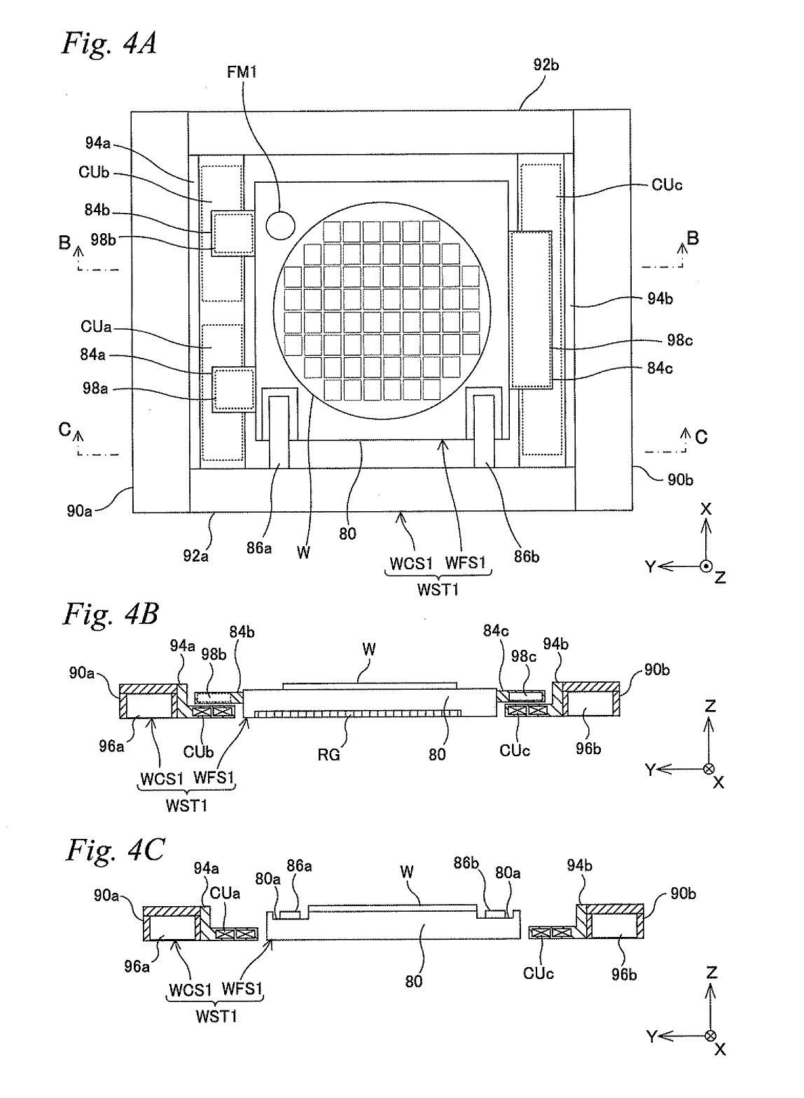

As shown in FIG. 4A, coarse movement stage WCS1 has a pair of coarse movement slider sections 90a and 90b which are placed parallel to each other, spaced apart in the Y-axis direction, and each of which is made up of a rectangular parallelepiped member whose longitudinal direction is in the X-axis direction, and a pair of coupling members 92a and 92b each of which is made up of a rectangular parallelepiped member whose longitudinal direction is in the Y-axis direction, and which couple the pair of coarse movement slider sections 90a and 90b with one ends and the other ends of the coupling members in the Y-axis direction. More specifically, coarse movement stage WCS1 is formed into a rectangular frame shape with a rectangular opening section, in its center portion, that penetrates in the Z-axis direction.

Inside (on the bottom portions of) coarse movement slider sections 90a and 90b, as shown in FIGS. 4B and 4C, magnet units 96a and 96b are housed respectively. Magnet units 96a and 96b correspond to the coil units housed inside first sections 14A₁ and 148₁ of surface plates 14A and 14B, respectively, and are each made of up a plurality of magnets placed in a matrix shape with the XY two-dimensional directions serving as a row direction and a column direction. Magnet units 96a and 96b configure, together with the coil units of surface plates 14A and 14B, a coarse movement stage driving system 62A (see FIG. 8) that is made up of a planar motor by the electromagnetic force (Lorentz force) drive method that is capable of generating drive forces in the directions of six degrees of freedom to coarse movement stage WCS1, which is disclosed in, for example, U.S. Patent Application Publication No. 2003/0085676 and the like. Further, similarly thereto, magnet units, which coarse movement stage WCS2 (see FIG. 2) of wafer stage WST2 has, and the coil units of surface plates 14A and 14B configure a coarse movement stage driving system 62B (see FIG. 8) made up of a planar motor.

Incidentally, while coarse movement stages WCS1 and WCS2 of the embodiment have the configuration in which only coarse movement slider sections 90a and 90b have the magnet units of the planar motors, this is not intended to be limiting, and the magnet unit can be placed also at coupling members 92a and 92b. Further, the actuators to drive coarse movement stages WCS1 and WCS2 are not limited to the planar motors by the electromagnetic force (Lorentz force) drive method, but for example, planar motors by a variable magnetoresistance drive method or the like can be used. Further, the drive directions of coarse movement stages WCS1 and WCS2 are not limited to the directions of six degrees of freedom, but can be, for example, only directions of three degrees of freedom (X, Y, θz) within the XY plane. In this case, coarse movement stages WCS1 and WCS2 should be levitated above surface plates 14A and 14B, for example, using static gas bearings (e.g. air bearings). Further, in the embodiment, while the planar motor of a moving magnet type is used as each of coarse movement stage driving systems 62A and 62B, this is not intended to be limiting, and a planar motor of a moving coil type in which the magnet unit is placed at the surface plate and the coil unit is placed at the coarse movement stage can also be used.

On the side surface on the −Y side of coarse movement slider section 90a and on the side surface on the +Y side of coarse movement slider section 90b, guide members 94a and 94b that function as a guide used when fine movement stage WFS1 is finely driven are respectively fixed. As shown in FIG. 4B, guide member 94a is made up of a member having an L-like sectional shape arranged extending in the X-axis direction and its lower surface is placed flush with the lower surface of coarse movement slider section 90a. Guide member 94b is configured and placed similar to guide member 94a, although guide member 94b is bilaterally symmetric to guide member 94a.

Inside (on the bottom surface of) guide member 94a, a pair of coil units CUa and CUb, each of which includes a plurality of coils placed in a matrix shape with the XY two-dimensional directions serving as a row direction and a column direction, are housed at a predetermined distance in the X-axis direction (see FIG. 4A). Meanwhile, inside (on the bottom portion of) guide member 94b, one coil unit CUc, which includes a plurality of coils placed in a matrix shape with the XY two-dimensional directions serving as a row direction and a column direction, is housed (see FIG. 4A). The magnitude and the direction of the electric current supplied to each of the coils that configure coil units CUa to CUc are controlled by main controller 20 (see FIG. 8).

Coupling member 92a is formed to be hollow, and piping members, wiring members and the like, which are not illustrated, used to supply the power usage to fine movement stage WFS1 are housed inside. Inside coupling members 92a and/or 92b, various types of optical members (e.g. an aerial image measuring instrument, an uneven illuminance measuring instrument, an illuminance monitor, a wavefront aberration measuring instrument, and the like) can be housed.

In this case, when wafer stage WST1 is driven with acceleration/deceleration in the Y-axis direction on surface plate 14A, by the planar motor that configures coarse movement stage driving system 62A (e.g. when wafer stage WST1 moves between exposure station 200 and measurement station 300), surface plate 14A is driven in a direction opposite to wafer stage WST1 according to the so-called law of action and reaction (the law of conservation of momentum) owing to the action of a reaction force by the drive of wafer stage WST1, in the case where surface plate driving system 60A described previously does not generate the drive force in the Y-axis direction.

Further, when wafer stage WST 2 is driven in the Y-axis direction on surface plate 14B, surface plate 14B is also driven in a direction opposite to wafer stage WST2 according to the so-called law of action and reaction (the law of conservation of momentum) owing to the action of a reaction force of a drive force of wafer stage WST2, in the case where surface plate driving system 60B described previously does not generate the drive force in the Y-axis direction. More specifically, surface plates 14A and 14B function as the countermasses and the momentum of a system composed of wafer stages WST1 and WST2 and surface plates 14A and 14B as a whole is conserved and movement of the center of gravity does not occur. Consequently, any inconveniences do not arise such as the uneven loading acting on surface plates 14A and 14B owing to the movement of wafer stages WST1 and WST2 in the Y-axis direction.

Further, by the action of a reaction force of a drive force in the X-axis direction of wafer stages WST1 and WST2, surface plates 14A and 14B function as the countermasses.

As shown in FIGS. 4A and 4B, fine movement stage WFS1 is equipped with a main section 80 made up of a member having a rectangular shape in a planar view, a pair of fine movement slider sections 84a and 84b fixed to the side surface on the +Y side of main section 80, and a fine movement slider section 84c fixed to the side surface on the −Y side of main section 80.

Main section 80 is formed by a material with a relatively small coefficient of thermal expansion, e.g., ceramics, glass or the like, and is supported by coarse movement stage WCS1 in a noncontact manner in a state where the bottom surface of the main section is located flush with the bottom surface of coarse movement stage WCS1. Main section 80 can be hollowed for reduction in weight.

In the center of the upper surface of main section 80, a wafer holder (not illustrated) that holds wafer W by vacuum adsorption or the like is placed. In the embodiment, the wafer holder by a so-called pin chuck method is used in which a plurality of support sections (pin members) that support wafer W are formed, for example, within an annular protruding section (rim section), and the wafer holder, whose one surface (front surface) serves as a wafer mounting surface, has a two-dimensional grating RG to be described later and the like arranged on the other surface (back surface) side. Incidentally, the wafer holder can be formed integrally with fine movement stage WFS1 (main section 80), or can be fixed to main section 80 so as to be detachable via, for example, a holding mechanism such as an electrostatic chuck mechanism, a clamp mechanism or the like. In this case, grating RG should be arranged on the back surface side of main section 80. Further, the wafer holder can be fixed to main section 80 by an adhesive agent or the like.

Further, in the vicinity of a corner on the +X side located on the +Y side of main section 80, a measurement plate FM1 is placed substantially flush with the surface of wafer W. On the upper surface of measurement plate FM1, the pair of first fiducial marks to be respectively detected by the pair of reticle alignment systems RA₁ and RA₂ (see FIGS. 1 and 8) described earlier and a second fiducial mark to be detected by primary alignment system AL1 (none of the marks are illustrated) are formed. In fine movement stage WFS2 of wafer stage WST2, as shown in FIG. 2, in the vicinity of a corner on the −X side located on the +Y side of main section 80, a measurement plate FM2 that is similar to measurement plate FM1 is fixed in a state substantially flush with the surface of wafer W.

In the center portion of the lower surface of main section 80 of fine movement stage WFS1, as shown in FIG. 4B, a plate having a predetermined thin plate shape, which is large to the extent of covering the wafer holder (mounting area of wafer W) and measurement plate FM1 (or measurement plate FM2 in fine movement stage WFS2), is placed in a state where its lower surface is located substantially flush with the other section (the peripheral section) (the lower surface of the plate does not protrude below the peripheral section). On one surface (the upper surface (or the lower surface)) of the plate, a two-dimensional grating RG (hereinafter, simply referred to as a grating RG) is formed. Grating RG includes a reflective diffraction grating (X diffraction grating) whose periodic direction is in the X-axis direction and a reflective diffraction grating (Y diffraction grating) whose periodic direction is in the Y-axis direction. The plate is formed by, for example, glass, and grating RG is created by engraving the graduations of the diffraction gratings at a pitch, for example, between 138 nm to 4 μm, e.g. at a pitch of 1 μm. Incidentally, grating RG can also cover the entire lower surface of main section 80. Further, the type of the diffraction grating used for grating RG is not limited to the one on which grooves or the like are formed, but for example, a diffraction grating that is created by exposing interference fringes on a photosensitive resin can also be employed.

As shown in FIG. 4A, the pair of fine movement slider sections 84a and 84b are each a plate-shaped member having a roughly square shape in a planar view, and are placed apart at a predetermined distance in the X-axis direction, on the side surface on the +Y side of main section 80. Fine movement slider section 84c is a plate-shaped member having a rectangular shape elongated in the X-axis direction in a planar view, and is fixed to the side surface on the −Y side of main section 80 in a state where one end and the other end in its longitudinal direction are located on straight lines parallel to the Y-axis that are substantially collinear with the centers of fine movement slider sections 84a and 84b.

The pair of fine movement slider sections 84a and 84b are each supported by guide member 94a described earlier, and fine movement slider section 84c is supported by guide member 94b. More specifically, fine movement stage WFS1 (WFS2) is supported at three noncollinear positions with respect to coarse movement stage WCS1 (WCS2).

Inside fine movement slider sections 84a to 84c, magnet units 98a, 98b and 98c, which are each made up of a plurality of permanent magnets (and yokes that are not illustrated) placed in a matrix shape with the XY two-dimensional directions serving as a row direction and a column direction, are housed, respectively, so as to correspond to coil units CUa to CUc that guide members 94a and 94b of coarse movement stage WCS1 have. Magnet unit 98a together with coil unit CUa, magnet unit 98b together with coil unit CUb, and magnet unit 98c together with coil unit CUc respectively configure three planar motors by the electromagnetic force (Lorentz force) drive method that are capable of generating drive forces in the X-axis, Y-axis and Z-axis directions, as disclosed in, for example, U.S. Patent Application Publication No. 2003/0085676 and the like, and these three planar motors configure a fine movement stage driving system 64A (see FIG. 8) that drives fine movement stage WFS1 in directions of six degrees of freedom (X, Y, Z, θx, θy and θz).

In wafer stage WST2 as well, three planar motors composed of coil units that coarse movement stage WCS2 has and magnet units that fine movement stage WFS2 has are configured likewise, and these three planar motors configure a fine movement stage driving system 64B (see FIG. 8) that drives fine movement stage WFS2 in directions of six degrees of freedom (X, Y, Z, θx, θy and θz).

Fine movement stage WFS1 is movable in the X-axis direction, with a longer stroke compared with the directions of the other five degrees of freedom, along guide members 94a and 94b arranged extending in the X-axis direction. The same applies to fine movement stage WFS2.

In the embodiment, when broadly driving coarse movement stage WCS1 (or WCS2) with acceleration/deceleration in the X-axis direction (e.g. in the cases such as when a stepping operation between shot areas is performed during exposure), main controller 20 drives coarse movement stage WCS1 (or WCS2) in the X-axis direction by the planar motors that configure coarse movement stage driving system 62A (or 62B), and along with this drive, main controller 20 gives the initial velocity, which drives fine movement stage WFS1 (or WFS2) in the same direction as with coarse movement stage WCS1 (or WCS2), to fine movement stage WFS1 (or WFS2), via fine movement stage driving system 64A (or 64B) (drives fine movement stage WFS1 (or WFS2) in the same direction as with coarse movement stage WCS1 (or WCS2)). Accordingly, fine movement stage WFS1 (or WFS2) can be made to function as the so-called countermass, which make it possible, as a consequence, to decrease a movement distance of fine movement stage WFS1 (or WFS2) in the opposite direction that accompanies the movement of coarse movement stage WCS1 (or WCS2) in the X-axis direction (that is caused by a reaction force of the drive force). Especially, in the case where coarse movement stage WCS1 (or WCS2) performs an operation including the step movement in the X-axis direction, or more specifically, coarse movement stage WCS1 (or WCS2) performs an operation of alternately repeating the acceleration and the deceleration in the X-axis direction, the stroke in the X-axis direction needed for the movement of fine movement stage WFS1 (or WFS2) can be the shortest. On this operation, main controller 20 should give fine movement stage WFS1 (or WFS2) the initial velocity with which the center of gravity of the entire system of wafer stage WST1 (or WST2) that includes the fine movement stage and the coarse movement stage performs constant velocity motion in the X-axis direction. With this operation, fine movement stage WFS1 (or WFS2) performs a reciprocal motion within a predetermined range with the position of coarse movement stage WCS1 (or WCS2) serving as a reference. Consequently, as the movement stroke of fine movement stage WFS1 (or WFS2) in the X-axis direction, the distance that is obtained by adding some margin to the predetermined range should be prepared. Such details are disclosed in, for example, U.S. Patent Application Publication No. 2008/0143994 and the like.

Further, as described earlier, since fine movement stage WFS1 is supported at the three noncollinear positions by coarse movement stage WCS1, main controller 20 can tilt fine movement stage WFS1 (i.e. wafer W) at an arbitrary angle (rotational amount) in the θx direction and/or the θy direction with respect to the XY plane by, for example, appropriately controlling a drive force (thrust) in the Z-axis direction that is made to act on each of fine movement slider sections 84a to 84c. Further, main controller 20 can make the center portion of fine movement stage WFS1 bend in the +Z direction (into a convex shape), for example, by making a drive force in the +θx direction (a counterclockwise direction on the page surface of FIG. 4B) on each of fine movement slider sections 84a and 84b and also making a drive force in the −θx direction (a clockwise direction on the page surface of FIG. 4B) on fine movement slider section 84c. Further, main controller 20 can also make the center portion of fine movement stage WFS1 bend in the +Z direction (into a convex shape), for example, by making drive forces in the −θy direction and the +θy direction (a counterclockwise direction and a clockwise direction when viewed from the +Y side, respectively) on fine movement slider sections 84a and 84b, respectively. Main controller 20 can also perform the similar operations with respect to fine movement stage WFS2.

Incidentally, in the embodiment, as fine movement stage driving systems 64A and 64B, the planar motors of a moving magnet type are used, but this is not intended to be limiting, and planar motors of a moving coil type in which the coil units are placed at the fine movement slider sections of the fine movement stages and the magnet units are placed at the guide members of the coarse movement stages can also be used.

Between coupling member 92a of coarse movement stage WCS1 and main section 80 of fine movement stage WFS1, as shown in FIG. 4A, a pair of tubes 86a and 86b used to transmit the power usage from the outside to fine movement stage WFS1 are installed. Incidentally, although the illustration is omitted in the drawings including FIG. 4A, actually, the pair of tubes 86a and 86b are each made up of a plurality of tubes. One ends of tubes 86a and 86b are connected to the side surface on the +X side of coupling member 92a and the other ends are connected to the inside of main section 80, respectively via a pair of recessed sections 80a (see FIG. 4C) with a predetermined depth each of which is formed from the end surface on the −X side toward the +X direction with a predetermined length, on the upper surface of main section 80. As shown in FIG. 40, tubes 86a and 86b are configured not to protrude above the upper surface of fine movement stage WFS1. Between coupling member 92a of coarse movement stage WCS2 and main section 80 of fine movement stage WFS2 as well, as shown in FIG. 2, a pair of tubes 86a and 86b used to transmit the power usage from the outside to fine movement stage WFS2 are installed.

For example as shown in FIG. 2, the pair of tubes 86a and 86b of wafer stage WST1 are connected to the pair of flat tubes Ta₂, respectively, via coupling member 92a. To be more precise, inside coupling member 92a, a plurality of tubes (piping/wiring members) bundled within tubes 86a and 86b are connected to the same number of tubes (piping/wiring members) arranged in a line in their width direction within flat tubes Ta₂. Similarly, the pair of tubes 86a and 86b of wafer stage WST2 are connected to the pair of flat tubes Tb₂, respectively, via the inside of coupling member 92a.

Flat tubes Ta₂ and Tb₂ and flat tubes Ta₁ and Tb₁ (including piping/wiring members inside) that are described later can be bent and twisted as is described later.

As shown in FIGS. 2 and 3, one ends of the pair of flat tubes Ta₂ are connected to the side surface of wafer stage WST1 (coupling member 92a), and the other ends are connected to the pair of flat tubes Ta₁ via a tube carrier TCa₁ that configures a part of tube carrier device TCa placed on the −X side of base board 12. The pair of flat tubes Ta₂ each has one end portion and the other end portion of its flat surface that are respectively connected to the side surface of wafer stage WST1 (coupling member 92a) and tube carrier TCa₁, with its center being bent, in a state where the one end portion and the other end portion are substantially parallel to the XY plane.

One ends and the other ends of the pair of flat tubes Tb₂ are connected to the side surface of wafer stage WST2 (coupling member 92a) and the pair of flat tubes Tb₁ via a tube carrier TCb₁ that configures a part of tube carrier device TCb placed on the +X side of base board 12. Incidentally, a configuration can also be employed in which a pair of flat tubes are each divided, and either of the divided tubes serving as flat tubes Ta₁ and Tb₁ are connected to tube carriers TCa₁ and TCb₁ and the other of the divided tubes serving as flat tubes Ta₂ and Tb₂ are connected to tube carriers TCa₁ and TCb₁.

Flat tubes Ta₁ and Tb₁ are connected to various types of power usage sources (not illustrated), e.g. an electric power supply, a gas tank, a compressor, a vacuum pump or the like, along the −X end and the +X end of base board 12, respectively, or through the inside of base board 12. The power usage is supplied from the power usage sources (not illustrated) to fine movement stage WFS1 sequentially via the pair of flat tubes Ta₁, tube carrier TCa₁, the pair of flat tubes Ta₂, coupling member 92a of coarse movement stage WCS1 and the pair of tubes 86a and 86b. Similarly, the power usage is supplied from the power usage sources (not illustrated) to fine movement stage WFS2 sequentially via the pair of flat tubes Tb₁, tube carrier TCb₁, the pair of flat tubes Tb₂, coupling member 92a of coarse movement stage WCS2 and the pair of tubes 86a and 86b.

As shown in FIGS. 2 and 3, tube carrier devices TCa and TCb are placed on the −X side and the +X side of base board 12, respectively. In this case, since tube carrier devices TCa and TCb are similarly configured, tube carrier device TCa is focused on and its configuration and the like are described below.

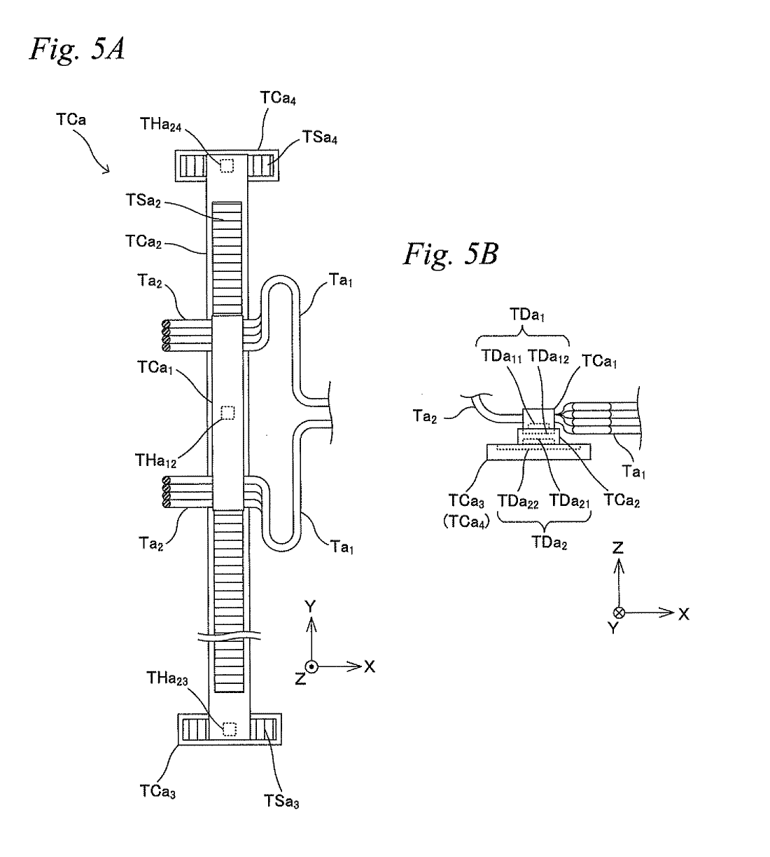

FIG. 5A shows a plan view of tube carrier device TCa and FIG. 5B shows a side view (a view viewed from the −Y direction) of tube carrier device TCa. As shown in FIGS. 5A and 5B, tube carrier device TCa is equipped with tube carrier (Y slider) TCa₁ that holds flat tubes Ta₁ and Ta₂ and moves in the Y-axis direction according to movement of wafer stage WST1, an X slider TCa₂ that configures a guide used on movement of tube carrier TCa₁ and moves in the X-axis direction, and a pair of support sections TCa₃ and TCa₄ that support one end portion and the other end portion of X slider TCa₂ in its longitudinal direction and guides X slider TCa₂ in the X-axis direction.

As shown in FIG. 5A, tube carrier TCa₁ is made up of a rectangular parallelepiped member whose longitudinal direction is in the Y-axis direction. In this case, the length of tube carrier TCa₁ in the longitudinal direction is substantially equal to the length in the Y-axis direction of coupling member 92a of wafer stage WST1 (see FIG. 2). To the +X end surface and the −X end surface in the vicinity of both ends of tube carrier TCa₁ in the longitudinal direction, one each pair of flat tubes Ta₁ and Ta₂ are connected.

As shown in FIGS. 5A and 5B, a pair of flat tubes Ta₁ are twisted at an angle of 90 degrees in the vicinity of connecting sections with tube carrier TCa₁ so that the vicinity of one end of each of the flat tubes looks like a rope-like member in a planar view and a section that looks like a rope is bent into a roughly U-like shape in a planar view.

As shown in FIGS. 2 and 5A, X slider TCa₂ that supports tube carrier TCa₁ is placed on the −X side of surface plate 14A with the Y-axis direction serving as its longitudinal direction, and its both ends are supported by a pair of support sections TCa₃ and TCa₄ that are installed on the floor surface with surface plate 14A in between in the Y-axis direction. In this case, the upper surface (+Z surface) of X slider TCa₂ play a role as a guide surface used on movement of tube carrier TCa₁. The length of X slider TCa₂ in the longitudinal direction (Y-axis direction) is slightly longer than the length of surface plate 14A in the Y-axis direction (see FIG. 2).

Support sections TCa₃ and TCa₄ are each made up of a member with the X-axis direction serving as its longitudinal direction, and are placed on the floor surface (see FIGS. 3 and 5B). The upper surfaces (+Z surfaces) of support sections TCa₃ and TCa₄ serve as guide surfaces used on movement of X slider TCa₂. Incidentally, while the length of each of support sections TCa₃ and TCa₄ in the longitudinal direction is, in actuality, substantially equal to the movement distance of wafer stage WST1 in the X-axis direction, the length in the longitudinal direction is illustrated as being shorter than the actual proportion for the sake of convenience of illustration in FIGS. 5A and 4A and the other drawings.

Tube carrier TCa₁ and X slider TCa₂ that configure tube carrier device TCa are respectively driven by a first drive device TDa₁ and a second drive device TDa₂ (see FIG. 5B) which a tube carrier driving system TDA (see FIG. 8) is equipped with.

As shown in FIG. 5B, first drive device TDa₁ includes a liner motor that has a mover TDa₁₁ including a plurality of permanent magnets (or a plurality of coils) arranged at tube carrier TCa₁ and a stator TDa₁₂ including a plurality of coils (or a plurality of permanent magnets) arranged at X slider TCa₂. In this case, stator TDa₁₂ is arranged extending in the Y-axis direction within a range that is at least around the same as a movement stroke of wafer stage WST1. First drive device TDa₁ drives tube carrier TCa₁ in the Y-axis direction above X slider TCa₂, with a stroke that is substantially equal to the movement stroke of wafer stage WST1. Note that tube carrier TCa₁ is supported in a noncontact manner above X slider TCa₂ via air bearings (not illustrated).

As shown in FIG. 5B, second drive device TDa₂ includes a pair of liner motors that have a pair of movers TDa₂₁ respectively arranged at the ±Y ends of X slider TCa₂, and stators TDa₂₂ respectively arranged at support sections TCa₃ and TCa₄ so as to correspond to the pair of movers TDa₂₁. Movers TDa₂₁ each includes a plurality of permanent magnets (or a plurality of coils), and stators TDa₂₂ each includes a plurality of a plurality of coils (or a plurality of permanent magnets). Stators TDa₂₂ are arranged extending in the X-axis direction within a range that is around the same as a movement stroke of wafer stage WST1. Second drive device TDa₂ drives X slider TCa₂ above support sections TCa₃ and TCa₄ with a stroke that is substantially equal to the movement stroke of wafer stage WST1. Note that both ends of X slider TCa₂ are supported in a noncontact manner above support sections TCa₃ and TCa₄ via air bearings (not illustrated).

Positional information of tube carrier TCa₁ in the Y-axis direction with respect to X slider TCa₂ and positional information of the ±Y ends of X slider TCa₂ in the X-axis direction with respect to each of support sections TCa₃ and TCa₄ are measured by a first measurement section TEa₁ and a second measurement section TEa₂ (see FIG. 8) that configure a tube carrier position measuring system TEA (see FIG. 8).

As shown in FIG. 5A, first measurement section TEa₁ includes a Y linear encoder that has a head section THa₁₂ arranged at the bottom portion of tube carrier TCa₁ and a Y scale TSa₂ placed on the upper surface of X slider TCa₂ that is opposed to the bottom surface of tube carrier TCa₁. In this case, on the surface of Y scale TSa₂, a grating whose periodic direction is in the Y-axis direction is formed. In first measurement section TEa₁ (see FIG. 8), head section THa₁₂ irradiates Y scale TSa₂ with a measurement beam and receives a plurality of diffraction lights generated at the surface of Y scale TSa₂, thereby measuring positional information of head section THa₁₂ with respect to Y scale TSa₂ in the Y-axis direction, or more specifically, positional information of tube carrier TCa₁ with respect to X slider TCa₂ in the Y-axis direction.

Meanwhile, as shown in FIG. 5A, first measurement section TEa₂ (see FIG. 8) includes a pair of X linear encoders that have a pair of head sections THa₂₃ and THa₂₄ arranged at the bottom portion of the ±Y ends of X slider TCa₂ and a pair of X scales TSa₃ and TSa₄ respectively arranged on the upper surfaces of support sections TCa₃ and TCa₄ that are opposed to the bottom surfaces of the ±Y ends of X slider TCa₂. In this case, on the surface of each of the pair of X scales TSa₃ and TSa₄, a grating whose periodic direction is in the X-axis direction is formed. In second measurement section TEa₂, head section THa₂₃ irradiates X scale TSa₃ with a measurement beam and receives a plurality of diffraction lights generated at X scale TSa₃, and based on the light-receiving result, measures positional information of head section THa₂₃ with respect to X scale TSa₃ in the X-axis direction, or more specifically, positional information of the −Y end of X slider TCa₂ with respect to support section TCa₃ in the X-axis direction. Similarly, in second measurement section TEa₂, head section THa₂₄ irradiates X scale TSa₄ with a measurement beam and receives a plurality of diffraction lights generated at X scale TSa₄, and based on the light-receiving result, measures positional information of head section THa₂₄ with respect to X scale TSa₄ in the X-axis direction, or more specifically, positional information of the +Y end of X slider TCa₂ with respect to support section TCa₄ in the X-axis direction. Main controller 20 (see FIG. 8) obtains positional information of X slider TCa₂ in the X-axis direction and the θz direction from the measurement results of the two heads.

The measurement results of tube carrier position measuring system TEA (first and second measurement sections TEa₁ and TEa₂) are transmitted to main controller 20 (see FIG. 8). Based on the received measurement results, main controller 20 controls the positions of tube carrier TCa₁ and X slider TCa₂ such that tube carrier TCa₁ and X slider TCa₂ follow wafer stage WST1.

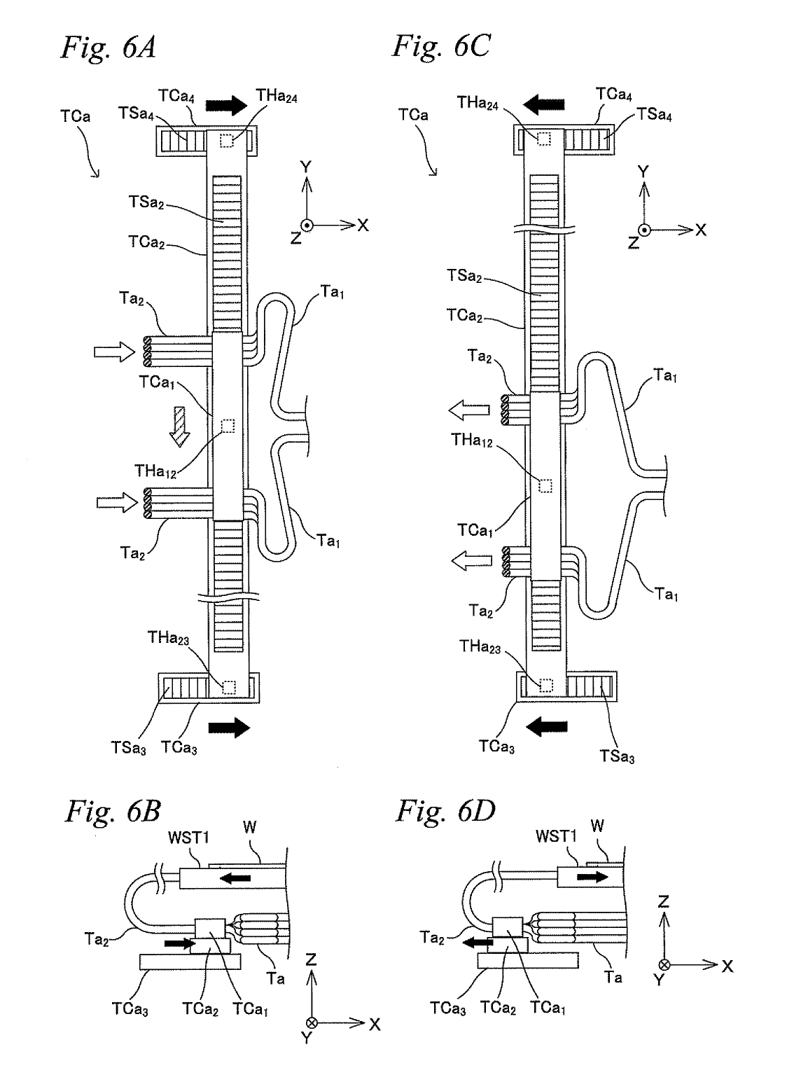

Next, an example of the follow-up drive of tube carrier TCa₁ with respect to wafer stage WST1 that is performed in the present embodiment is described, with reference to FIGS. 6A to 6D.

When main controller 20 drives wafer stage WST1 in the Y-axis direction, e.g. the −Y direction, main controller 20 controls first drive device TDa₁ (see FIG. 5B) to drive tube carrier TCa₁ in the −Y direction (a direction of an arrow with hatching) in FIG. 6A such that tube carrier TCa₁ follows wafer stage WST1. In this manner, the Y-position of tube carrier TCa₁ is constantly maintained at substantially the same Y-position as with wafer stage WST1. Therefore, flat tubes Ta₁ and Ta₂ connected to wafer stage WST1 are also move in the −Y direction (the direction of the arrow with hatching) so as to follow wafer stage WST1.

Furthermore, when main controller 20 drives wafer stage WST1 in the X-axis direction, e.g. the −X direction as indicated by a black arrow in FIG. 6B, main controller 20 controls second drive device TDa₂ (see FIG. 5B) to drive X slider TCa₂ in a direction opposite to wafer stage WST1, i.e. the +X direction (a direction of a black arrow), thereby driving tube carrier TCa₁ in the +X direction. In this case, main controller 20 drives X slider TCa₂ (i.e. tube carrier TCa₁) in a direction opposite to wafer stage WST1, by a distance that is substantially the same as a movement distance of wafer stage WST1 in the X-axis direction.

As described above, in stage device 50 (see FIG. 1) related to the present embodiment, when wafer stage WST1 moves in the −X direction, tube carrier TCa₁ moves in the +X direction in accordance with the movement of wafer stage WST1, or more specifically, as shown in FIG. 6B, while wafer stage WST1 pushes out flat tube Ta₂ in the −X direction, tube carrier TCa₁ pulls flat tube Ta₂ in the +X direction, and thereby displacement of flat tube Ta₂ in the X-axis direction is cancelled out, and accordingly the overhang of flat tube Ta₂ in the −X direction is prevented, which is different from the case where the X-position of tube carrier TCa₁ is fixed. Consequently, exposure apparatus 100 does not grow in size. In contrast, in the case where the X-position of tube carrier TCa₁ is fixed, when wafer stage WST1 moves in the −X direction, flat tube Ta₂ overhangs in the −X direction while changing the position of its curved section (the section bent into a U-like shape), and therefore, a space used to prevent contact between flat tube Ta₂ and other members becomes necessary for stage device 50.

Meanwhile, regarding flat tube Ta₁, X slider TCa₂ (tube carrier TCa₁ supported by X slider TCa₂) is driven, for example, in the +X direction, and thereby a pair of opposed surfaces, which are opposed to each other, of the bent section having a roughly U-like shape in a planar view approach, as shown in FIG. 6A. Therefore, an area on the further +X side than the bent section having a roughly U-like shape (the side connected to the power usage sources (not illustrated)) of flat tubes Ta₁ does not move in the X-axis direction.

In this case, in tube carrier device TCa of the present embodiment, as shown in FIG. 6B, when X slider TCa₂ (and tube carrier TCa₁) is driven in the +X direction, X slider TCa₂ is located below surface plate 14A (e.g. see FIG. 3). When driving wafer stage WST1 in the +X direction (a direction of a black arrow) as shown in FIG. 6D, main controller 20 (see FIG. 8) controls second drive device TDa₂ (see FIG. 5B) to drive X slider TCa₂ in a direction opposite to wafer stage WST1, i.e. the −X direction (a direction of a black arrow), thereby driving tube carrier TCa₁ in the −X direction. Also in this case, main controller 20 drives X slider TCa₂ in a direction opposite to wafer stage WST1, by a distance that is substantially the same as a movement distance of wafer stage WST1 in the X-axis direction. This prevents flat tube Ta₂ and surface plate 14A from coming in contact with each other, when wafer stage WST1 moves in the +X direction.

Meanwhile, regarding flat tube Ta₁, X slider TCa₂ (tube carrier TCa₁ supported by X slider TCa₂) is driven in the −X direction, and thereby a pair of opposed surfaces, which are opposed to each other, of the bent section having a roughly U-like shape move away from each other, as shown in FIG. 6C. Therefore, an area on the further +X side than the bent section (the side connected to the power usage sources (not illustrated)) of flat tubes Ta₁ does not move in the X-axis direction.

In the present embodiment, as described above, by driving and controlling tube carrier device TCa according to the movement of wafer stage WST1, it becomes possible to drive and control wafer stage WST1 without undergoing a tensile force (drag) from flat tubes Ta₁ and Ta₂ and further without widening a space where flat tubes Ta₁ and Ta₂ occupy within exposure apparatus 100.

Similarly to tube carrier device TCa described above, another tube carrier, tube carrier device TCb is also configured of tube carrier TCb₁ that moves in the Y-axis direction while holding flat tubes Tb₁ and Tb₂, an X slider TCb₂ that moves in the X-axis direction while supporting tube carrier TCb₁, and a pair of support section TCb₃ and TCb₄ that support both ends of X slider TCb₂. Tube carrier TCb₁ and X slider TCb₂ are driven by a tube carrier driving system TDB (see FIG. 8) that is configured similar to tube carrier driving system TDA (first and second drive devices TDa₁ and TDa₂) described earlier. The position of tube carrier TCb₁ with respect to X slider TCb₂ in the Y-axis direction and the position of the ±Y ends of X slider TCb₂ with respect to support sections TCb₃ and TCb₄, respectively, in the X-axis direction are measured by a tube carrier position measuring system TEB (see FIG. 8) that is configured similar to tube carrier position measuring system TEA (first and second measurement sections TEa₁ and TEa₂). More specifically, as shown in FIG. 2, tube carrier position measuring system TEB has a first measurement section TEb₁ (see FIG. 8) that includes a head section THb₁₂ and a Y scale TSb₂ and measures Y positional information of tube carrier TCb₁, and a second measurement section TEb₂ (see FIG. 8) that includes head sections THb₂₃ and THb₂₄ and X scales TSb₃ and TSB₄ and measures X positional information (including θz positional information) of X slider TCb₂.

The measurement results of tube carrier position measuring system TEB are transmitted to main controller 20 (see FIG. 8). Based on the received measurement results, main controller 20 drives and controls tube carrier device TCb (tube carrier (Y slider) TCb₁ and X slider TCb₂) according to the position of wafer stage WST2, similarly to tube carrier device TCa described earlier. Accordingly, it becomes possible to drive and control wafer stage WST2 without undergoing a tensile force (drag) from flat tubes Tb₁ and Tb₂ and further without widening a space where flat tubes Tb₁ and Tb₂ occupy within exposure apparatus 100.

Next, a measurement system that measures positional information of wafer stages WST1 and WST2 is described. Exposure apparatus 100 has a fine movement stage position measuring system 70 (see FIG. 8) that measures positional information of fine movement stages WFS1 and WFS2, and coarse movement stage position measuring systems 68A and 68B (see FIG. 8) that measures positional information of coarse movement stages WCS1 and WCS2 respectively.

Fine movement stage position measuring system 70 has a measurement bar 71 shown in FIG. 1. Measurement bar 71 is placed below first sections 14A₁ and 14B₁ of the pair of surface plates 14A and 14B, as shown in FIG. 3. As is obvious from FIGS. 1 and 3, measurement bar 71 is made up of a beam-like member having a rectangular sectional shape with the Y-axis direction serving as its longitudinal direction, and both ends in the longitudinal direction are each fixed to main frame BD in a suspended state via suspended members 74. More specifically, main frame BD and measurement bar 71 are integrated. The +Z side half (upper half) of measurement bar 71 is placed between second section 14A₂ of surface plate 14A and second section 14B₂ of surface plate 14B, and the −Z side half (lower half) is housed inside recessed section 12a formed at base board 12. Further, a predetermined clearance is formed between measurement bar 71 and each of surface plates 14A and 14B and base board 12, and measurement bar 71 is in a state noncontact with the members other than main frame BD. Measurement bar 71 is formed by a material with a relatively low coefficient of thermal expansion (e.g. invar, ceramics, or the like).

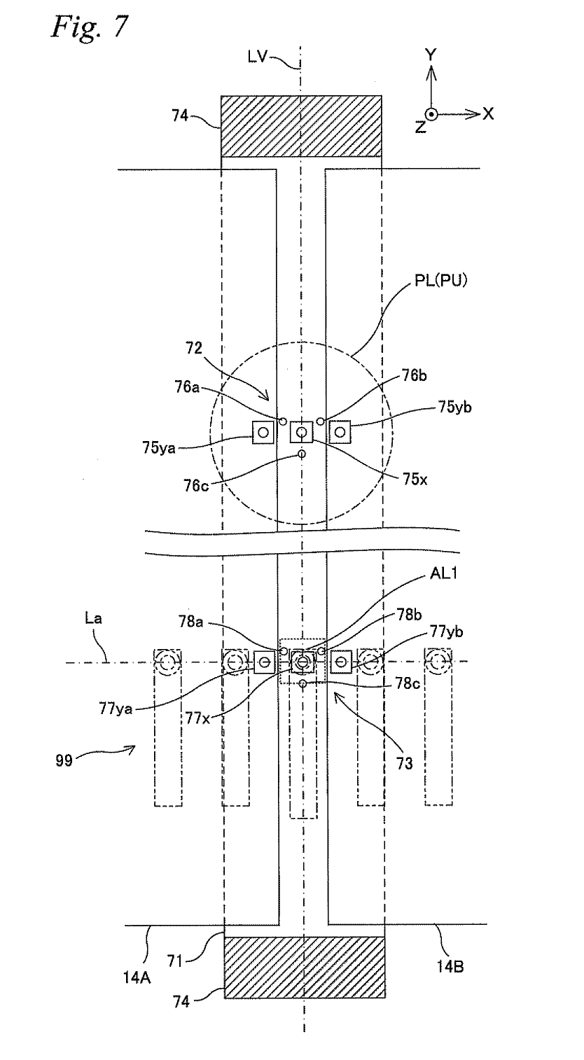

At measurement bar 71, as shown in FIG. 7, a first measurement head group 72 used when measuring positional information of the fine movement stage (WFS1 or WFS2) located below projection unit PU and a second measurement head group 73 used when measuring positional information of the fine movement stage (WFS1 or WFS2) located below alignment device 99 are arranged. Incidentally, alignment systems AL1 and AL2₁ to AL2₄ are shown in virtual lines (two-dot chain lines) in FIG. 7 in order to make the drawing easy to understand. Further, in FIG. 7, the reference signs of alignment systems AL2₁ to AL2₄ are omitted.

As shown in FIG. 7, first measurement head group 72 is placed below projection unit PU and includes a one-dimensional encoder head for X-axis direction measurement (hereinafter, shortly referred to as an X head or an encoder head) 75x, a pair of one-dimensional encoder heads for Y-axis direction measurement (hereinafter, shortly referred to as Y heads or encoder heads) 75ya and 75yb, and three Z heads 76a, 76b and 76c.

X head 75x, Y heads 75ya and 75yb and the three Z heads 76a to 76c are placed in a state where their positions do not vary, inside measurement bar 71. X head 75x is placed on reference axis LV, and Y heads 75ya and 75yb are placed at the same distance apart from X head 75x, on the −X side and the +X side, respectively. In the embodiment, as each of the three encoder heads 75x, 75ya and 75yb, a diffraction interference type head having a configuration in which a light source, a photodetection system (including a photodetector) and various types of optical systems are unitized is used, which is similar to the encoder head disclosed in, for example, U.S. Patent Application Publication No. 2007/0288121 and the like.

When wafer stage WST1 (or WST2) is located directly under projection optical system PL (see FIG. 1), X head 75x and Y heads 75ya and 75yb each irradiate a measurement beam on grating RG (see FIG. 4B) placed on the lower surface of fine movement stage WFS1 (or WFS2), via a gap between surface plate 14A and surface plate 14B or a light-transmitting section (e.g. an opening) formed at first section 14A₁ of surface plate 14A and first section 14B₁ of surface plate 14B, and receive diffraction light from grating RG, thereby obtaining positional information within the XY plane (also including rotational information in the θz direction) of fine movement stage WFS1 (or WFS2). More specifically, an X liner encoder 51 (see FIG. 8) is configured of X head 75x that measures the position of fine movement stage WFS1 (or WFS2) in the X-axis direction using the X diffraction grating that grating RG has, and a pair of Y liner encoders 52 and 53 (see FIG. 8) are configured of the pair of Y heads 75ya and 75yb that measure the position of fine movement stage WFS1 (or WFS2) in the Y-axis direction using the Y diffraction grating of grating RG. The measurement value of each of X head 75x and Y heads 75ya and 75yb is supplied to main controller 20 (see FIG. 8), and main controller 20 measures (computes) the position of fine movement stage WFS1 (or WFS2) in the X-axis direction based on the measurement value of X head 75x, and the position of fine movement stage WFS1 (or WFS2) in the Y-axis direction based on the average value of the measurement values of the pair of Y head 75ya and 75yb. Further, main controller 20 measures (computes) the position in the θz direction (rotational amount around the Z-axis) of fine movement stage WFS1 (or WFS2) using the measurement value of each of the pair of Y linear encoders 52 and 53.

In this case, an irradiation point (detection point), on grating RG, of the measurement beam emitted from X head 75x coincides with the exposure position that is the center of exposure area IA (see FIG. 1) on wafer W. Further, a midpoint of a pair of irradiation points (detection points), on grating RG, of the measurement beams respectively emitted from the pair of Y heads 75ya and 75yb coincides with the irradiation point (detection point), on grating RG, of the measurement beam emitted from X head 75x. Since main controller 20 computes positional information of fine movement stage WFS1 (or WFS2) in the Y-axis direction based on the average of the measurement values of the two Y heads 75ya and 75yb, the positional information of fine movement stage WFS1 (or WFS2) in the Y-axis direction is substantially measured at the exposure position that is the center of irradiation area (exposure area) IA of illumination light IL irradiated on wafer W. More specifically, the measurement center of X head 75x and the substantial measurement center of the two Y heads 75ya and 75yb coincide with the exposure position. Consequently, by using X linear encoder 51 and Y linear encoders 52 and 53, main controller 20 can perform measurement of the positional information within the XY plane (including the rotational information in the θz direction) of fine movement stage WFS1 (or WFS2) directly under (on the back side of) the exposure position at all times.

As each of Z heads 76a to 76c, for example, a head of a displacement sensor by an optical method similar to an optical pickup used in a CD drive device or the like is used. The three Z heads 76a to 76c are placed at the positions corresponding to the respective vertices of an isosceles triangle (or an equilateral triangle). Z heads 76a to 76c configure a surface position measuring system 54 (see FIG. 8) that irradiates the lower surface of fine movement stage WFS1 (or WFS2) with a measurement beam parallel to the Z-axis from below, and receives reflected light reflected by the surface of the plate on which grating RG is formed (or the formation surface of the reflective diffraction grating), thereby measuring the surface position (position in the Z-axis direction) of fine movement stage WFS1 (or WFS2) at the respective irradiation points. The measurement value of each of the three Z heads 76a to 76c is supplied to main controller 20 (see FIG. 8).

Further, the center of gravity of the isosceles triangle (or the equilateral triangle) whose vertices are at the three irradiation points on grating RG of the measurement beams respectively emitted from the three Z heads 76a to 76c coincides with the exposure position that is the center of exposure area IA (see FIG. 1) on wafer W. Consequently, based on the average value of the measurement values of the three Z heads 76a to 76c, main controller 20 can perform measurement of positional information in the Z-axis direction (surface position information) of fine movement stage WFS1 (or WFS2) directly under the exposure position at all times. Further, main controller 20 measures (computes) the rotational amount in the θx direction and the θy direction, in addition to the position in the Z-axis direction, of fine movement stage WFS1 (or WFS2) based on the measurement values of the three Z heads 76a to 76c.

Second measurement head group 73 has an X head 77x that configures an X liner encoder 55 (see FIG. 8), a pair of Y heads 77ya and 77yb that configure a pair of Y linear encoders 56 and 57 (see FIG. 8), and three Z heads 78a, 78b and 78c that configure a surface position measuring system 58 (see FIG. 8). The respective positional relations of the pair of Y heads 77ya and 77yb and the three Z heads 78a to 78c with X head 77x serving as a reference are similar to the respective positional relations described above of the pair of Y heads 75ya and 75yb and the three Z heads 76a to 76c with X head 75x serving as a reference. An irradiation point (detection point), on grating RG, of the measurement beam emitted from X head 77x coincides with the detection center of primary alignment system ALL More specifically, the measurement center of X head 77x and the substantial measurement center of the two Y heads 77ya and 77yb coincide with the detection center of primary alignment system ALL Consequently, main controller 20 can perform measurement of positional information within the XY plane and surface position information of fine movement stage WFS2 (or WFS1) at the detection center of primary alignment system AL1 at all times.

Incidentally, while each of X heads 75x and 77x and Y heads 75ya, 75yb, 77ya and 77yb of the embodiment has the light source, the photodetection system (including the photodetector) and the various types of optical systems (none of which are illustrated) that are unitized and placed inside measurement bar 71, the configuration of the encoder head is not limited thereto, and for example, the light source and the photodetection system can be placed outside the measurement bar. In such a case, the optical systems placed inside the measurement bar, and the light source and the photodetection system are connected to each other via, for example, an optical fiber or the like. Further, a configuration can also be employed in which the encoder head is placed outside the measurement bar and only a measurement beam is guided to the grating via an optical fiber placed inside the measurement bar. Further, the rotational information of the wafer in the θz direction can be measured using a pair of the X liner encoders (in this case, there should be one Y linear encoder). Further, the surface position information of the fine movement stage can be measured using, for example, an optical interferometer. Further, instead of the respective heads of first measurement head group 72 and second measurement head group 73, three encoder heads in total, which include at least one XZ encoder head whose measurement directions are the X-axis direction and the Z-axis direction and at least one YZ encoder head whose measurement directions are the Y-axis direction and the Z-axis direction, can be arranged in the placement similar to that of the X head and the pair of Y heads described earlier.

When wafer stage WST1 moves between exposure station 200 and measurement station 300 on surface plate 14A, coarse movement stage position measuring system 68A (see FIG. 8) measures positional information of coarse movement stage WCS1 (wafer stage WST1). The configuration of coarse movement stage position measuring system 68A is not limited in particular, and includes an encoder system or an optical interferometer system (or the optical interferometer system and the encoder system can be combined). In the case where coarse movement stage position measuring system 68A includes the encoder system, for example, a configuration can be employed in which the positional information of coarse movement stage WCS1 is measured by irradiating a scale (e.g. two-dimensional grating) fixed (or formed) on the upper surface of coarse movement stage WCS1 with measurement beams from a plurality of encoder heads fixed to main frame BD in a suspended state along the movement course of wafer stage WST1 and receiving the diffraction light of the measurement beams. In the case where coarse movement stage measuring system 68A includes the optical interferometer system, a configuration can be employed in which the positional information of wafer stage WST1 is measured by irradiating the side surfaces of coarse movement stage WCS1 with measurement beams from an X optical interferometer and a Y optical interferometer that have a measurement axis parallel to the X-axis and a measurement axis parallel to the Y-axis respectively and receiving the reflected light of the measurement beams.

A coarse movement stage position measuring system 68B (see FIG. 8) has a configuration similar to that of coarse movement stage position measuring system 68A, and measures positional information of coarse movement stage WCS2 (wafer stage WST2). Based on the measurement values of coarse movement stage position measuring systems 68A and 68B, main controller 20 individually controls coarse movement stage driving systems 62A and 62B to control the position of each of coarse movement stages WCS1 and WCS2 (wafer stages WST1 and WST2).

Further, exposure apparatus 100 is also equipped with a relative position measuring system 66A and a relative position measuring system 66B (see FIG. 8) that measure the relative position between coarse movement stage WCS1 and fine movement stage WFS1 and the relative position between coarse movement stage WCS2 and fine movement stage WFS2, respectively. While the configuration of relative position measuring systems 66A and 66B is not limited in particular, relative position measuring systems 66A and 662 can each be configured of, for example, a gap sensor including a capacitance sensor. In this case, the gap sensor can be configured of, for example, a probe section fixed to coarse movement stage WCS1 (or WCS2) and a target section fixed to fine movement stage WFS1 (or WFS2). Incidentally, the configuration of the relative position measuring system is not limited thereto, but for example, the relative position measuring system can be configured using, for example, a liner encoder system, an optical interferometer system or the like.

FIG. 8 shows a block diagram that shows input/output relations of main controller 20 that is configured of a control system of exposure apparatus 100 as the central component and performs overall control of the respective components. Main controller 20 includes a workstation (or a microcomputer) and the like, and performs overall control of the respective components of exposure apparatus 100 such as surface plate driving systems 60A and 60B, coarse movement stage driving systems 62A and 62B, fine movement stage driving systems 64A and 64B and tube carrier driving systems TDA and TDB.

In exposure apparatus 100 configured as described above, exposure on wafers in a predetermined number of lots or on a predetermined number of wafers is performed by alternately using wafer stages WST1 and WST2. More specifically, in parallel with performing the exposure operation on a wafer held by one of wafer stages WST1 and WST2, main controller 20 performs wafer exchange and at least a part of wafer alignment on the other of wafer stages WST1 and WST2, and thereby the parallel processing operation described above is performed using wafer stages WST1 and WST2 alternately, in a manner similar to a typical exposure apparatus of a twin-wafer-stage type. In exposure apparatus 100, the operation similar to the typical exposure apparatus of a twin-wafer-stage type is performed, and accordingly the detailed description is omitted herein.

However, in exposure apparatus 100, on the parallel processing operation described above, when driving wafer stages WST1 and WST2 in the X-axis direction and the Y-axis direction, main controller 20 drives tube carriers TCa₁ and TCb₁ via tube carrier driving systems TDA and TDB as described previously, in response to the movement of the wafer stages. In this case, wafer stage WST1 moves in the X-axis direction between a position, with which the center of wafer stage WST1 is located on the +X side of reference axis LV, and the −X end on surface plate 14A. And, wafer stage WST2 moves in the X-axis direction between a position, with which the center of wafer stage WST2 is located on the −X side of reference axis LV, and the +X end on surface plate 14B. However, when wafer stage WST1 (WST2) is driven in the X-axis direction by main controller 20, tube carrier TCa₁ (TCb₁) is driven in a direction opposite to the wafer stage by the same distance as the drive distance of the wafer stage, and therefore, when wafer stage WST1 (WST2) broadly moves in the X-axis direction, a tensile force acting on flat tubes Ta₁ and Ta₂ (Tb₁ and Tb₂) are substantially constant, and the protruding amount of flat tube Ta₂ (Tb₂) that protrudes outside in the X-axis direction is also substantially constant. More specifically, a U-like shape bending section having a constant curvature is constantly formed at flat tube Ta₁ (Tb₂).

As described in detail above, in exposure apparatus 100 of the embodiment, tube carrier device TCa (TCb) is arranged which has tube carrier TCa₁ (TCb₁) to move in the Y-axis direction while holding flat tube Ta₁ (Ta₂) that supplies the power usage to wafer stage WST1 (WST2), X slider TCa₂ (TCb₂) to move in the X-axis direction while supporting tube carrier TCa₁ (TCb₁), the pair of support sections TCa₃ and TCa₄ (TCb₃ and TCb₄) to support the both ends of X slider TCa₂ (TCb₂). And, main controller 20 drives tube carrier TCa₁ (TCb₁) in the Y-axis direction according to the movement of wafer stage WST1 (WST2) in the Y-axis direction, and drives tube carrier TCa₁ (TCb₁) integrally with slider TCa₂ (TCb₂) in the relative direction (opposite direction) according to the movement of wafer stage WST1 (WST2) in the X-axis direction. Therefore, wafer stage WST1 (WST2) is hardly receive the drag (tensile force) from flat tube Ta₁ and Ta₂ (Tb₁ and Tb₂), which makes it possible to drive wafer stage WST1 (WST2) with high accuracy. Further, on the movement of wafer stage WST1 (WST2) in the X-axis direction that is the direction of movement of tube carrier TCa₁ (TCb₁) with a short stroke, flat tube Ta₁ and Ta₂ (Tb₁ and Tb₂) do not protrude outside.

Further, according to exposure apparatus 100 of the embodiment, at least a part of encoder heads 75x, 75ya and 75yb, which irradiate the measurement surfaces, parallel to the XY plane, of fine movement stages WFS1 and WFS2 with measurement beams and receive the light from gratings RG placed on the measurement surfaces, is placed at measurement bar 71 placed on the side opposite to projection optical system PL (−Z side) with respect to the guide surface (the upper surfaces of surface plates 14A and 14B) used on the movement of fine movement stages WFS1 and WFS2 (wafer stages WST1 and WST2) Further, during the exposure operation and during the wafer alignment (mainly, during the measurement of the alignment marks), first measurement head group 72 and second measurement head group 73 fixed to measurement bar 71 are respectively used in the measurement of the positional information (the positional information within the XY plane and the surface position information) of fine movement stage WFS1 (or WFS2) that holds wafer W. And, since the encoder heads 75x, 75ya and 75yb and Z heads 76a to 76c that configure first measurement head group 72, and encoder heads 77x, 77ya and 77yb and Z heads 78a to 78c that configure second measurement head group 73 can respectively irradiate grating RG placed on the bottom surface of fine movement stage WFS1 (or WFS2) with measurement beams from directly below at the shortest distance. Therefore, the measurement error of encoder heads 75x, 75ya, 75yb and the like caused by the temperature fluctuation of the surrounding atmosphere of wafer stages WST1 and WST2, e.g. air fluctuation, becomes small, which makes it possible to perform high-precision measurement of the positional information of fine movement stages WFS1 and WFS2. Consequently, even if fine movement stages WFS1 and WFS2 grow in size, the positional information of fine movement stages WFS1 and WFS2 is measured with high precision by fine movement stage position measuring system 70, and based on the measurement information, i.e., the positional information of fine movement stages WFS1 and WFS2 measured with high precision, main controller 20 measures the positions of fine movement stages WFS1 and WFS2 with high precision.

Further, first measurement head group 72 measures the positional information within the XY plane and the surface position information of fine movement stage WFS1 (or WFS2) at the point that substantially coincides with the exposure position that is the center of exposure area IA on wafer W, and second measurement head group 73 measures the positional information within the XY plane and the surface position information of fine movement stage WFS1 (or WFS2) at the point that substantially coincides with the detection area of primary alignment system AL1. Consequently, occurrence of the so-called Abbe error caused by the positional error within the XY plane between the measurement point and the exposure position is restrained, and also in this regard, the high-precision measurement of the positional information of fine movement stage WFS1 or WFS2 becomes possible.

Incidentally, in the embodiment above, the case has been described where main controller 20 drives tube carrier TCa₁ (TCb₁) according to the movement of wafer stage WST1 (WST2), or more specifically, main controller 20 drives tube carrier TCa₁ (TCb₁) based on the measurement information of fine movement stage position measuring system 70, coarse movement stage position measuring system 68A (68B), and tube carrier position measuring system TEA (TEB). However, since the required accuracy for position control of the tube carriers is lower compared with that of the wafer stages, it is also possible to make the tube carriers move in conjunction with the movement of wafer stage WST1 (WST2) by, for example, control of the electric current value or the like, without performing the measurement of the positional information.

Incidentally, in place of tube carrier devices TCa and TCb in the embodiment above, a configuration can also employed in which tube carriers TCa₁ and TCb₁ move in the XY direction on surface plates 14A and 14B or base board 12 while holding flat tubes Ta₁ and Ta₂ (Tb₁ and Tb₂). In this case, movers are arranged at the bottom sections of tube carriers TCa₁ and TCb₁, and planer motors (such as planar motors by the electromagnetic force (Lorentz force) drive method or the variable magnetoresistance drive method) that are configured of such movers and stators arranged in surface plates 14A and 14B or base board 12 can be employed as drive devices of tube carriers TCa₁ and TCb₁.

Further, in the embodiment above, the configuration is employed in which the positional information of tube carrier devices TCa and TCb, i.e. the positional information of tube carriers TCa₁ and TCb₁ with respect to X sliders TCa₂ and TCb₂ in the Y-axis direction and the positional information of the ±Y ends of X sliders TCa₂ and TCb₂ with respect to support sections TCa₃ and TCa₄ and with respect to support sections TCb₃ and TCb₄ in the X-axis direction, respectively, are measured using the encoder (first measurement section TEa₁ and second measurement section TEa₂). In this case, it is also possible to employ, for example, an interferometer, instead of the encoder, as the position measuring instrument of tube carrier devices TCa and TCb.

Further, in the embodiment above, while in exposure apparatus 100 equipped with the two wafer stages WST1 and WST2, tube carrier devices TCa and TCb are respectively arranged at the two stages, it is also possible to arrange the tube carriers having the similar configuration in exposure apparatus 100 equipped with only one wafer stage or three or more wafer stages.

Incidentally, while the exposure apparatus of the embodiment above has the two surface plates that correspond to the two wafer stages, the number of the surface plates is not limited to two, and can be, for example, one. Further, a measurement stage, for example, which has an aerial image measuring instrument, an uneven illuminance measuring instrument, an illuminance monitor, a wavefront aberration measuring instrument and the like, can be placed on the surface plate, as disclosed in, for example, U.S. Patent Application Publication No. 2007/0201010.

Further, in the embodiment above, while both ends of measurement bar 71 in the longitudinal direction are supported in a suspended manner by main frame BD, this is not intended to be limiting, and for example, the mid portion (which can be arranged at a plurality of positions) in the longitudinal direction of the measurement bar can be supported on the base board by an empty-weight canceller as disclosed in, for example, U.S. Patent Application Publication No. 2007/0201010.

Further, the motor to drive surface plates 14A and 14B on base board 12 is not limited to the planar motor by the electromagnetic force (Lorentz force) drive method, but for example, can be a planar motor (or a linear motor) by a variable magnetoresistance drive method. Further, the motor is not limited to the planar motor, but can be a voice coil motor that includes a mover fixed to the side surface of the surface plate and a stator fixed to the base board. Further, the surface plates can be supported on the base board via the empty-weight canceller as disclosed in, for example, U.S. Patent Application Publication No. 2007/0201010 and the like. Further, the drive directions of the surface plates are not limited to the directions of six degrees of freedom, but for example, can be only the Y-axis direction, or only the XY two-axial directions. In this case, the surface plates can be levitated above the base board by static gas bearings (e.g. air bearings) or the like. Further, in the case where the movement direction of the surface plates can be only the Y-axis direction, the surface plates can be mounted on, for example, a Y guide member arranged extending in the Y-axis direction so as to be movable in the Y-axis direction.

Further, in the embodiment above, while the grating is placed on the lower surface of the fine movement stage, in other words, the surface that is opposed to the upper surface of the surface plate, this is not intended to be limiting, and the main section of the fine movement stage is made up of a solid member that can transmit light, and the grating can be placed on the upper surface of the main section. In this case, since the distance between the wafer and the grating is closer compared with the embodiment above, the Abbe error, which is caused by the difference in the Z-axis direction between the surface subject to exposure of the wafer that includes the exposure point and the reference surface (the placement surface of the grating) of position measurement of the fine movement stage by encoders 51, 52 and 53, can be reduced. Further, the grating can be formed on the back surface of the wafer holder. In this case, even if the wafer holder expands or the attachment position with respect to the fine movement stage shifts during exposure, the position of the wafer holder (wafer) can be measured according to the expansion or the shift.

Further, in the embodiment above, while the case has been described as an example where the encoder system is equipped with the Y head and the pair of X heads, this is not intended to be limiting, and for example, one or two two-dimensional head(s) (2D head(s)) whose measurement directions are the two directions that are the X-axis direction and the Y-axis direction can be placed inside the measurement bar. In the case of arranging the two 2D heads, their detection points can be set at the two points that are spaced apart in the X-axis direction at the same distance from the exposure position as the center, on the grating.

Further, in the embodiment above, the measurement beams emitted from the encoder heads and the measurement beams emitted from the Z heads are irradiated on the gratings of the fine movement stages via a gap between the two surface plates or the light-transmitting section formed at each of the surface plates. In this case, as the light-transmitting section, holes each of which is slightly larger than a beam diameter of each of the measurement beams are formed at each of surface plates 14A and 14B taking the movement range of surface plate 14A or 14B as the countermass into consideration, and the measurement beams can be made to pass through these multiple opening sections. Further, for example, it is also possible that pencil-type heads are used as the respective encoder heads and the respective Z heads, and opening sections in which these heads are inserted are formed at each of the surface plates.

Further, while the case has been described where the embodiment above is applied to the dry type exposure apparatus, the embodiment above can also be applied to a wet type (liquid immersion type) exposure apparatus that is disclosed in, for example, PCT International Publication No. 99/49504, U.S. Patent Application Publication No. 2005/0259234 and the like.

Incidentally, in the embodiment above, while the case has been described where the exposure apparatus is a scanning stepper, this is not intended to be limiting, and the exposure apparatus can be a static exposure apparatus such as a stepper. Even in the stepper or the like, occurrence of position measurement error caused by air fluctuation can be reduced to almost zero by measuring the position of a stage on which an object that is subject to exposure is mounted using an encoder, and therefore, the position of the stage can be set with high precision based on the measurement values of the encoder, and as a consequence, it becomes possible to perform high-precision transfer of a reticle pattern onto the object. Further, the embodiment above can also be applied to a reduced projection exposure apparatus by a step-and-stitch method that synthesizes a shot area and a shot area.

Further, the magnification of the projection optical system in the exposure apparatus of the embodiment above is not only a reduction system, but also can be either an equal magnifying system or a magnifying system, and the projection optical system is not only a dioptric system, but also can be either a catoptric system or a catadioptric system, and in addition, the projected image can be either an inverted image or an erected image.

Further, illumination light IL is not limited to ArF excimer laser light (with a wavelength of 193 nm), but can be ultraviolet light such as KrF excimer laser light (with a wavelength of 248 nm), or vacuum ultraviolet light such as F₂ laser light (with a wavelength of 157 nm). As disclosed in, for example, U.S. Pat. No. 7,023,610, a harmonic wave, which is obtained by amplifying a single-wavelength laser beam in the infrared or visible range emitted by a DFB semiconductor laser or fiber laser with a fiber amplifier doped with, for example, erbium (or both erbium and ytteribium), and by converting the wavelength into ultraviolet light using a nonlinear optical crystal, can also be used as vacuum ultraviolet light.

Further, in the embodiment above, illumination light IL of the exposure apparatus is not limited to the light having a wavelength more than or equal to 100 nm, and it is needless to say that the light having a wavelength less than 100 nm can be used For example, the embodiment above can be applied to an EUV (Extreme Ultraviolet) exposure apparatus that uses EUV light in a soft X-ray range (e.g. a wavelength range from 5 to 15 nm). In addition, the embodiment above can also be applied to an exposure apparatus that uses charged particle beams such as an electron beam or an ion beam.

Further, in the embodiment above, a light transmissive type mask (reticle) is used, which is obtained by forming a predetermined light-shielding pattern (or a phase pattern or a light-attenuation pattern) on a light-transmitting substrate, but instead of this reticle, as disclosed in, for example, U.S. Pat. No. 6,778,257, an electron mask (which is also called a variable shaped mask, an active mask or an image generator, and includes, for example, a DMD (Digital Micromirror Device) that is a type of a non-emission type image display element (spatial light modulator) or the like) on which a light-transmitting pattern, a reflection pattern, or an emission pattern is formed according to electronic data of the pattern that is to be exposed can also be used. In the case of using such a variable shaped mask, a stage on which a wafer, a glass plate or the like is mounted is scanned relative to the variable shaped mask, and therefore the equivalent effect to the embodiment above can be obtained by measuring the position of this stage using an encoder system.

Further, the embodiment above can also be applied to an exposure apparatus (a lithography system) in which line-and-space patterns are formed on wafer W by forming interference fringes on wafer W, as disclosed in, for example, PCT International Publication No. 2001/035168.

Moreover, the embodiment above can also be applied to an exposure apparatus that synthesizes two reticle patterns on a wafer via a projection optical system and almost simultaneously performs double exposure of one shot area on the wafer by one scanning exposure, as disclosed in, for example, U.S. Pat. No. 6,611,316.

Incidentally, an object on which a pattern is to be formed (an object subject to exposure on which an energy beam is irradiated) in the embodiment above is not limited to a wafer, but may be another object such as a glass plate, a ceramic substrate, a film member, or a mask blank.

The application of the exposure apparatus is not limited to the exposure apparatus used for manufacturing semiconductor devices, but the embodiment above can be widely applied also to, for example, an exposure apparatus for manufacturing liquid crystal display elements in which a liquid crystal display element pattern is transferred onto a rectangular glass plate, and to an exposure apparatus for manufacturing organic EL, thin-film magnetic heads, imaging devices (such as CCDs), micromachines, DNA chips or the like. Further, the embodiment above can also be applied to an exposure apparatus that transfers a circuit pattern onto a glass substrate, a silicon wafer or the like not only when producing microdevices such as semiconductor devices, but also when producing a reticle or a mask used in an exposure apparatus such as an optical exposure apparatus, an EUV exposure apparatus, an X-ray exposure apparatus, and an electron beam exposure apparatus.

Incidentally, the disclosures of all publications, the PCT International Publications, the U.S. Patent Application Publications and the U.S. patents that are cited in the description so far related to exposure apparatuses and the like are each incorporated herein by reference.

Electron devices such as semiconductor devices are manufactured through the following steps: a step where the function/performance design of a device is performed; a step where a reticle based on the design step is manufactured; a step where a wafer is manufactured using a silicon material; a lithography step where a pattern of a mask (the reticle) is transferred onto the wafer with the exposure apparatus (pattern formation apparatus) of the embodiment described earlier and the exposure method thereof; a development step where the exposed wafer is developed; an etching step where an exposed member of an area other than an area where resist remains is removed by etching; a resist removing step where the resist that is no longer necessary when the etching is completed is removed; a device assembly step (including a dicing process, a bonding process, and a packaging process); an inspection step; and the like. In this case, in the lithography step, the exposure method described earlier is executed using the exposure apparatus of the embodiment above and device patterns are formed on the wafer, and therefore, the devices with high integration degree can be manufactured with high productivity.

While the above-described embodiment of the present invention is the presently preferred embodiment thereof, those skilled in the art of lithography systems will readily recognize that numerous additions, modifications, and substitutions may be made to the above-described embodiment without departing from the spirit and scope thereof. It is intended that all such modifications, additions, and substitutions fall within the scope of the present invention, which is best defined by the claims appended below.

What is claimed is:

1. An exposure apparatus that exposes an object by irradiating the object with an energy beam, the apparatus comprising:
a movable body, which holds the object, to which one end of a power usage transmitting member is connected, and which is movable along a first plane parallel to a predetermined two-dimensional plane that includes a first axis and a second axis orthogonal to each other, the power usage transmitting member having flexibility that forms a transmission path used when a power usage for the exposure is transmitted between the movable body and a predetermined external device; and
an auxiliary movable body, which is placed on one side in a direction parallel to the first axis with respect to the movable body, to which the other end of the power usage transmitting member is connected, and which moves along a second plane parallel to the two-dimensional plane according to movement of the movable body and moves to the other side in the direction parallel to the first axis when the movable body moves to the one side in the direction parallel to the first axis.

2. The exposure apparatus according to claim 1, wherein
the first plane and the second plane are different in position in a direction parallel to a third axis that is orthogonal to the two-dimensional plane.

3. The exposure apparatus according to claim 1, wherein
the auxiliary movable body moves in a same direction as with the movable body when the movable body moves in the direction parallel to the second axis.

4. The exposure apparatus according to claim 1, wherein
the power usage transmitting member is folded back in the direction parallel to the first axis so as to be connected to the movable body and the auxiliary movable body.

5. The exposure apparatus according to claim 1, further comprising:
a drive system, which includes a first support member that supports the auxiliary movable body movable in a direction parallel to the second axis, a second support member that supports the first support member movable in the direction parallel to the first axis, a first motor that drives the auxiliary movable body along the first support member and a second motor that drives the first support member along the second support member, and which drives the auxiliary movable body in the direction parallel to the first axis and the direction parallel to the second axis.

6. The exposure apparatus according to claim 5, further comprising:
an auxiliary measurement system, which includes a first measurement system that measures positional information of the auxiliary movable body in the direction parallel to the second axis with respect to the first support member and a second measurement system that measures positional information of the first support member in the direction parallel to the first axis with respect to the second support member, and which measures positional information of the auxiliary movable body.

7. The exposure apparatus according to claim 6, further comprising:
a measurement system that measures positional information of the movable body within the two-dimensional plane; and
a control system that drives and controls the auxiliary movable body based on measurement information of the measurement system and the auxiliary measurement system.

8. A device manufacturing method, comprising:
exposing an object using the exposure apparatus according to claim 1; and
developing the object that has been exposed.
